(19) United States
(12) Patent Application Publication
(10) Pub. No.: US 2025/0166002 A1
(43) Pub. Date: May 22, 2025

(54) REWARDS AGGREGATION AND ALLOCATION SYSTEM

(71) Applicant: Wells Fargo Bank, N.A., San Francisco, CA (US)

(72) Inventors: Alan W. Hecht, Chanhassen, MN (US); Robert Shipley Jacobs, San Francisco, CA (US); Adam E. Vancini, Concord, CA (US)

(73) Assignee: Wells Fargo Bank, N.A., San Francisco, CA (US)

(21) Appl. No.: 17/978,860

(22) Filed: Nov. 1, 2022

(51) Int. Cl. G06Q 30/0226; G06Q 20/36; G06Q 30/0207

(52) U.S. Cl. CPC G06Q 30/0227; G06Q 20/36; G06Q 30/0215

(57) ABSTRACT

A system includes a first application programming interface (API) configured to receive an input via a user device to configure a rewards wallet account setting, and a second API configured to request data of the user from a plurality of rewards providers associated with the system, and receive an API response containing the data of the user from the plurality of rewards providers. The system includes a third API configured to convert the data of the user gathered from each of the plurality of rewards providers into a standardized rewards format where the standardized rewards format comprises standardized rewards points, aggregate the standardized rewards points, and allocate the aggregated standardized rewards points to one or more categories based on the rewards wallet account setting.

### BACKGROUND

Many credit card issuers, stores, and businesses offer rewards points to customers. For example, some credit card issuers, stores, and/or businesses may provide a predetermined number of rewards points for every dollar spent. Accordingly, as a customer continues to use the credit card or purchase items at the store/business, the customer accumulates rewards points. The customer can then redeem the rewards points. However, customers may accumulate multiple different rewards balances for each credit card, store, or business such that keeping track of their rewards balances is difficult, and such rewards balances may expire before the customer is able to accumulate a sufficient amount of rewards that can be used. Therefore, systems and methods aggregating different rewards to one account are desirable.

### SUMMARY

One embodiment relates to a system. The system includes a first application programming interface (API) configured to receive an input via a user device to configure a rewards wallet account setting. The system includes a second API configured to request, from a plurality of rewards providers associated with the system, data of the user and receive, from the plurality of rewards providers, an API response containing the data of the user. The system includes a third API configured to convert the data of the user gathered from each of the plurality of rewards providers into a standardized rewards format, where the standardized rewards format comprises standardized rewards points; aggregate the standardized rewards points; and allocate the aggregated standardized rewards points to one or more categories based on the rewards wallet account setting.

Another embodiment relates to a non-transitory computer readable media having computer-executable instructions embodied therein that, when executed by a server system, causes the server system to perform operations. The operations include receiving, from a first application programming interface (API) of the server system, an input received via a user device to configure a rewards wallet account setting; requesting, by the second API from a plurality of rewards providers associated with the server system, data of the user; receiving, by the second API and from the plurality of rewards providers, an API response containing the data of the user; converting, by a third API, the data of the user gathered from each of the plurality of rewards providers into a standardized rewards format, where the standardized rewards format comprises standardized rewards points; aggregating, by the third API, the standardized rewards points; and allocating, by the third API, the aggregated standardized rewards points to one or more categories based on the rewards wallet account setting.

Another embodiment relates to a method. The method includes receiving, from a first application programming interface (API) of the server system, an input received via a user device to configure a rewards wallet account setting; requesting, by the second API from a plurality of rewards providers associated with the server system, data of the user; receiving, by the second API and from the plurality of rewards providers, an API response containing the data of the user; converting, by a third API, the data of the user gathered from each of the plurality of rewards providers into a standardized rewards format, where the standardized rewards format comprises standardized rewards points; aggregating, by the third API, the standardized rewards points; and allocating, by the third API, the aggregated standardized rewards points to one or more categories based on the rewards wallet account setting.

### BRIEF DESCRIPTION OF THE FIGURES

FIG. 1 is a schematic diagram of a rewards collection and aggregation computing system, according to an example embodiment.

FIG. 2 is a flow diagram of a method for rewards data collection and aggregation, according to an example embodiment.

FIG. 3 is another flow diagram of a method for rewards data collection and aggregation, according to an example embodiment.

FIG. 4 is another flow diagram of a method for rewards data collection and aggregation, according to an example embodiment.

FIG. 5 is an illustration of a dynamic graphical user interface displayed on a user device for collecting user preferences to create a rewards account for the user, according to an example embodiment.

FIG. 6 is an illustration of a dynamic graphical user interface displayed on a user device showing the allocation and aggregation of rewards points, according to an example embodiment.

FIG. 7 is a schematic diagram of the flow of rewards data from one or more rewards providers through the rewards collection and aggregation computing system of FIG. 1, according to an example embodiment.

FIG. 8 is an illustration of a dynamic graphical user interface displayed on a user device showing the process of updating the allocation and aggregation of the rewards points, according to an example embodiment.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

According to example embodiments described herein, a rewards aggregation and allocation system is described and includes user devices, rewards providers, and a rewards collection and aggregation platform. The rewards providers may include one or more of a credit card issuer, a store, a merchant, a business (e.g., insurance, restaurants, airlines, banks, etc.), or another type of entity which provides rewards to a user, for example, based on the actions of the user (e.g., using a credit card, making purchases, etc.), financial account actions (e.g., opening a certain type of account, maintaining an account balance, setting up direct deposit, meeting a saving goals, etc.), and lifestyle actions and milestones (e.g., birthdays, completing chores, grades, healthy living, having a baby, adoption, getting good grades, achieving a savings goal, getting married, retiring, graduating a certain grade or reaching a certain grade in school, losing an amount of weight, reducing or stopping tobacco use, etc.). Users may receive rewards points from multiple different rewards providers. For example, a user may receive a first amount of rewards points from their credit card issuer based on purchasing an item using a credit card and a second amount of rewards points from a retail business based on purchasing an item from that business. In this case, the user has accrued two rewards points balances on two different accounts. The rewards point balances on different accounts may continue to increase as the user purchases more items or uses different credit cards. As these separate rewards account balances increase, or as the number of separate rewards accounts increase (e.g., due to the user using a different credit card issued by a different rewards provider, due to the user purchasing items from different stores, etc.) the user may find it increasingly difficult to keep track of all the different accounts and account balances, which may lead to rewards points expiring or simply losing track of rewards accounts (e.g., through non-use or due to low rewards balances)—in either event, resulting in a loss of rewards. Therefore, systems and methods for collecting rewards points from different rewards providers and aggregating the rewards points into one account associated with a user is desired.

In some embodiments, a platform is provided that interconnects the users and the rewards providers through a network of application programming interfaces (APIs) implemented by the platform and the rewards providers. Users may sign up to use the platform as a service to help the user manage their rewards points (e.g., rewards preferences, rewards allocations, etc.). More specifically, the user may use the platform to control the allocation of rewards points to different categories and manage which accounts may receive the rewards points. Such management may be implemented on a real-time basis. The rewards platform collects rewards points from multiple different rewards providers. For example, the rewards platform may collect the rewards points that a user earns from one or more credit card issuers, one or more retail stores, and one or more businesses. The rewards platform may then convert each of the rewards points into a standardized format because the rewards from each of the different rewards providers may not have the same value. For example, 1000 airline rewards points may correlate to 100 dollars while 1000 retail store rewards points may correlate to 10 dollars. Therefore, the rewards platform may convert the airline rewards points and retail store rewards points into a standardized format (e.g., a certain monetary amount based on money spent) so that the rewards platform may aggregate the rewards to create one rewards point balance.

For the rewards providers, according to example embodiments, the platform provides a mechanism to provide rewards to their customers while not requiring that the rewards provider develop and manage a rewards point infrastructure. Therefore, the rewards providers may receive the identity and data of the user (e.g., purchase history, personal data, account activity) and then send rewards points for the user to the rewards platform which collects and aggregates rewards points from different rewards providers for the user. In some embodiments, the APIs provide a mechanism for data sharing to effectively collect and aggregate rewards points, which conserves processing power and reduces bandwidth that would otherwise be used if the system relied on bespoke reward aggregation protocols for each participating rewards provider.

In various embodiments, users that sign up for the service may create a username that the user may then use to interact with the rewards providers in real time. The username uniquely identifies those two particular users. When the user interacts with the rewards provider (e.g., through a website, through a point-of-sale (POS), etc.), the user uses their username as a log-in credential and, on this basis, the rewards provider recognizes the user as being someone that utilizes the services of the platform. With this in mind, the rewards provider recognizes that it may send API calls to the platform to gain additional information about the user in real time. In various embodiments, the rewards platform and the rewards providers all provide various APIs that facilitate real-time interaction between the various entities. For the rewards providers, the APIs may be provided based on template APIs developed by the platform and reused by the rewards provider, or the APIs may be custom-written according to an API documentation of the platform.

In various embodiments, the customer may access an application or website of the platform to set preferences as to how their rewards are collected. For example, the user may decide and set preferences on which rewards providers they would like to collect rewards data from. As another example, the user may decide and set preferences on how they would like to allocate the rewards that are aggregated in their rewards account.

In various embodiments, such preferences may also be received from the user in real time (e.g., while the user is visiting the rewards website or application). In various embodiments, the platform is interconnected with various payment rails (e.g., Real Time Payments, ACH, Zelle, Venmo, Cashapp, and so on) that may be used to make payments to the user as a result of decisions made by the user concerning the allocation of their rewards.

Accordingly, the systems and methods provided herein tangibly improve computer hardware. Typically, a user may have a mobile device which stores multiple applications for monitoring multiple rewards account balances for different rewards providers. For example, a mobile device may include an airline rewards application for monitoring and managing the rewards points related to an airline, a grocery store rewards application for monitoring and managing the rewards points related to grocery purchases, and a restaurant rewards application for monitoring and managing the rewards points related to restaurant purchases. Each of these applications requires an increasing amount of power consumption, CPU clock cycles, memory allocation, and network bandwidth to run on the mobile device. However, the systems and methods described herein decrease the amount of power consumption, CPU clock cycles, memory storage, and network bandwidth to be used by the mobile device to monitor and manage rewards points across different sectors. More specifically, the rewards platform decreases the amount of processing power and memory store required by collecting and aggregating rewards points under one platform so that the monitoring and managing may be done by only one application that is downloaded and ran on the mobile device.

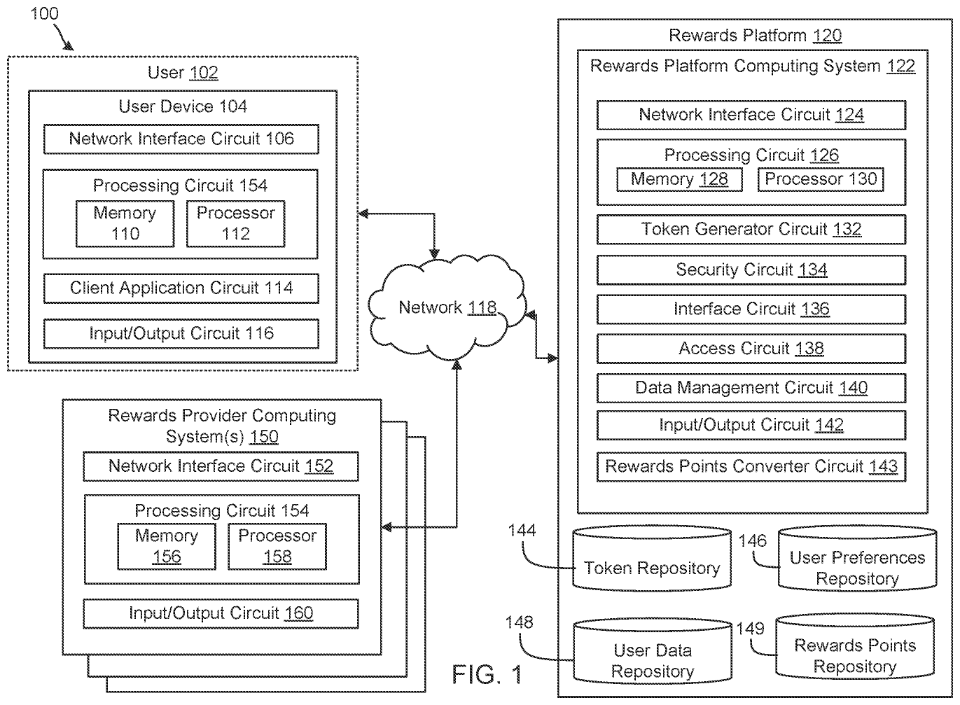

Referring now to FIG. 1, a schematic diagram of a rewards collection and aggregation computing system 100 is shown, according to an example embodiment. The rewards collection and aggregation computing system 100 includes a user device 104, a rewards platform computing system 122, and a rewards provider computing system(s) 150. The user device 104, the rewards platform computing system 122, and the rewards provider computing system(s) 150 are each communicably coupled and configured to exchange information over a network 118, which may include one or more of the Internet, cellular network, Wi-Fi, Wi-Max, a proprietary banking network, a proprietary retail or service provider network, or other type of wired or wireless network.

The user device 104 may be a computing device associated with a user 102 (e.g., owned by, used by, etc.). The user device 104 may be or include a mobile phone, a tablet, a laptop, a desktop computer, a point of sale device, a wearable device, a virtual/augmented reality (VR/AR) device, and/or other suitable user computing devices capable of accessing and communicating using local and/or global networks (e.g., the network 118). Wearable computing devices refer to types of devices that an individual wears, including, but not limited to, a watch (e.g., a smart watch), glasses (e.g., eye glasses, sunglasses, smart glasses, etc.), bracelet (e.g., a smart bracelet), etc.

The user 102 may be a customer or client of the rewards platform 120 associated with the rewards platform computing system 122 (e.g., an account holder). In some embodiments, the user 102 may not have a previous relationship with the rewards platform 120, and therefore, may only be a user of the features recited herein (e.g., with regard to the rewards collection and aggregation computing system 100). Accordingly, the user 102 may be an individual, a representative(s) of a rewards provider, any customer of the provider, and/or any user registered to utilize the rewards collection and aggregation computing system 100.

The user device 104 is shown to include a network interface circuit 106, a processing circuit 108, a client application 114, and an input/output circuit 116. The network interface circuit 106 is structured to establish connections with other computing systems (e.g., the rewards platform computing system 122, the rewards provider computing system(s) 150, etc.) via the network 118. Accordingly, the network interface circuit 106 enables the user device 104 to transmit and/or receive information to and/or from the rewards platform computing system 122 and the rewards provider computing system(s) 150 over the network 118. The network interface circuit 106 includes program logic that facilitates connection of the user device 104 to the network 118. For example, the network interface circuit 106 may include a combination of wireless network transceivers (e.g., a cellular modem, a NFC transceiver, a Bluetooth transceiver, a Wi-Fi transceiver, etc.) and/or wired network transceivers (e.g., an Ethernet transceiver). In some arrangements, the network interface circuit 106 includes the hardware and machine-readable media sufficient to support communication over multiple channels of data communication. Further, in some arrangements, the network interface circuit 106 includes cryptography capabilities to establish a secure or relatively secure communication session in which data communicated over the session is encrypted.

The processing circuit 108 includes a memory 110 and a processor 112. The memory 110 may be one or more memory or storage devices (e.g., RAM, ROM, Flash memory, hard disk storage) for storing data and/or computer code for completing and/or facilitating the various processes described herein. Memory 110 may be or include non-transient volatile memory, non-volatile memory, and non-transitory computer storage media. Memory 110 may include database components, object code components, script components, or other types of information structured for supporting the various activities and information structures described herein. The memory 110 may be coupled to the processor 112 and include computer code or instructions for executing one or more processes described herein. The processor 112 may be implemented as one or more processors, application specific integrated circuits (ASICs), field programmable gate arrays (FPGAs), a group of processing components, or other suitable electronic processing components. As such, the user device 104 is configured to run a variety of application programs and store associated data in the memory 110. One such application may be the client application 114.

The user device 104 includes a client application circuit 114 (also referred to herein as the platform client application 114) that is provided by and coupled to the rewards platform computing system 122. In some arrangements, the client application 114 may be a standalone application or be incorporated with an existing application of the user device 104 (e.g., integrated into a mobile banking application, a service provider application, etc.). The client application 114 may be downloaded by the user device 104 prior to its usage, hard coded into the memory 110 of the user device 104, or be a network-based or web-based interface application such that the rewards platform computing system 122 may provide a web browser to access the application, which may be executed remotely from the user device 104. In the example shown, the client application 114 is downloaded to the user device 104 and provided by the rewards platform computing system 122 via, for example, an app store for download. In the example shown, the client application 114 is structured as a rewards application (e.g., to collect and aggregate rewards points for the user 102 based on the preferences of the user 102). The client application 114 may be developed and maintained (e.g., provided with software updates on a regular or semi-regular basis) by the rewards platform 120 using the rewards platform computing system 122. Accordingly, the user device 104 may include software and/or hardware capable of implementing a network-based or web-based application. For example, in some instances, the client application 114 includes software such as HTML, XML, WML, SGML, PHP (Hypertext Preprocessor), CGI, and like languages.

In the latter web-based instance, the user 102 may have to log onto or access the web-based interface before usage of the application. Further, and in this regard, the client application 114 may be supported by the rewards platform computing system 122 via one or more servers, processors, network interface circuits, etc. that transmit applications for use to the user device 104. Furthermore, prior to use of the client application 114 and/or at various points throughout the use of the client application 114, the user 102 may be required to provide various authentication information or log-in credentials (e.g., a password, a personal identification number (PIN), a fingerprint scan, a retinal scan, a voice sample, a face scan, any other type of biometric security scan) to ensure that the user 102 associated with the user device 104 is authorized to use the client application 114.

The client application 114 is structured to provide displays (e.g., generated by the interface circuit 136 of the rewards platform computing system 122 and transmitted over the network 118) to the user 102 of the user device 104 in order to provide information pertaining to rewards allocation and management preferences (e.g., as described further herein). Accordingly, the user 102 may manage rewards allocation and management settings that are maintained and distributed by the rewards platform 120, via the client application 114.

The input/output circuit 116 is structured to receive communications from and provide communications to the user 102. In this regard, the input/output circuit 116 is structured to exchange data, communications, instructions, etc. with an input/output component of the user device 104. In one embodiment, the input/output circuit 116 includes an input/output device. In another embodiment, the input/output circuit 116 includes communication circuitry for facilitating the exchange of data, values, messages, and the like between an input/output device and the components of the user device 104. In yet another embodiment, the input/output circuit 116 includes machine-readable media for facilitating the exchange of information between an input/output device and the components of the user device 104. In still another embodiment, the input/output circuit 116 includes a combination of hardware components, communication circuitry, and machine-readable media.

For example, in some embodiments, the input/output circuit 116 may include suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or manipulation purposes. That is, the input/output circuit 116 provides an interface for the user 102 to interact with various applications (e.g., the client application 114) accessed by the user device 104.

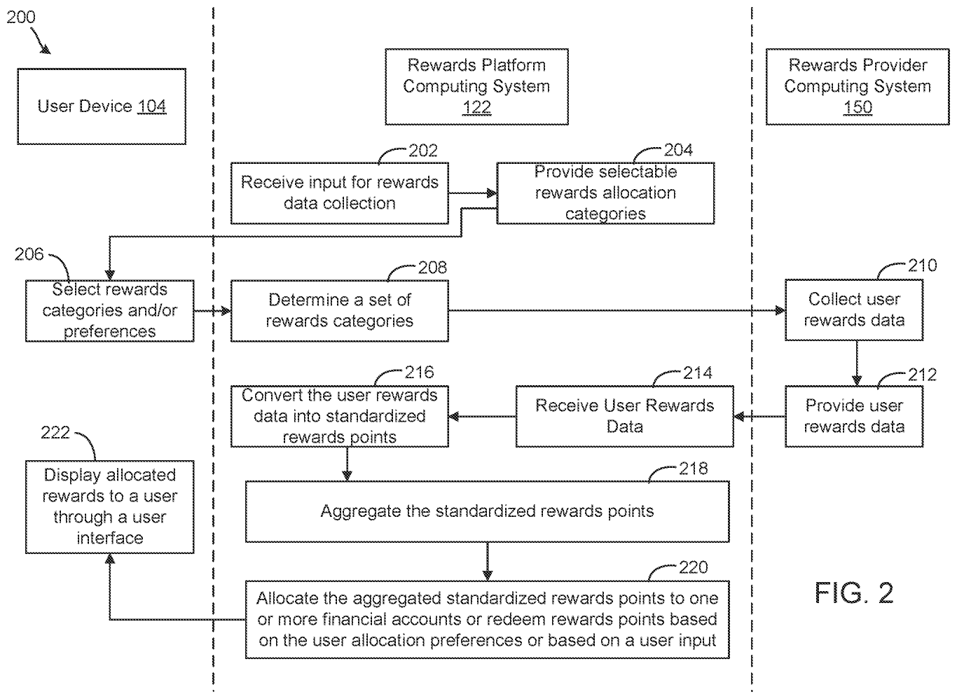

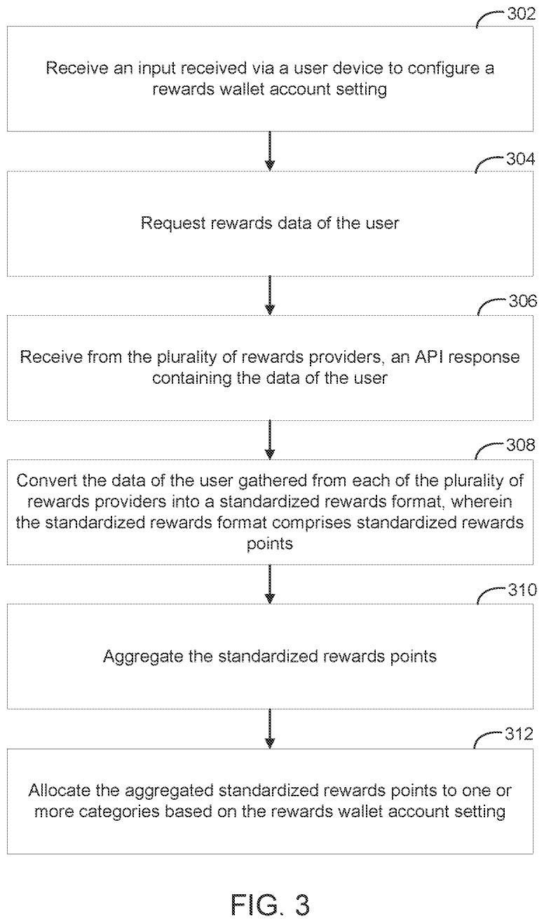

Still referring to FIG. 1, the rewards platform computing system 122 is associated with (e.g., owned, managed, and/or operated by) the rewards platform 120. In the example depicted, the rewards platform 120 is a financial institution capable of providing one or more products and services, such as the providing of various accounts, such as a demand deposit account, lending, money transfers, issuing credit and/or debit cards, wealth management, etc. Thus, the associated rewards platform computing system 122 is structured to provide or otherwise facilitate providing the one or more products and services to customers. Additionally, the rewards platform computing system 122 is structured to maintain, control access to, and provide data of the user 102 to rewards provider computing systems 150 (e.g., as described further below, with reference to FIGS. 2 and 3). As depicted, the rewards platform computing system 122 is a backend computer system. The rewards platform computing system 122 may be implemented using a computing system, such as a discrete server, a group of two or more computing devices/servers, a distributed computing network, a cloud computing network, and/or another type of computing system capable of accessing and communicating using local and/or global networks (e.g., the network 118).

The rewards platform computing system 122 includes a network interface circuit 124, a processing circuit 126, a token generator circuit 132, a security circuit 134, an interface circuit 136, an access circuit 138, a data management circuit 140, and an input/output circuit 142. The rewards platform computing system 122 also includes a token repository 144, a user preferences repository 146, and a user data repository 148. In an alternate embodiment, the token repository 144, and/or the user preferences repository 146, and/or the user data repository 148 may be a part of another computing system, accessed as needed by the rewards platform computing system 122.

The network interface circuit 124 is structured to establish communicable connections with other computing systems (e.g., the user device 104, the rewards provider computing system(s) 150, other computing systems, etc.), by way of the network 118. The network interface circuit 124 may include program logic that facilitates connection of the rewards platform computing system 122 to the network 118. For example, the network interface circuit 124 may include a combination of a wireless network transceivers (e.g., a NFC transceiver, a Bluetooth transceiver, a Wi-Fi transceiver, etc.) and/or a wired network transceiver (e.g., an Ethernet transceiver). In some arrangements, the network interface circuit 124 includes the hardware and machine-readable media sufficient to support communication over multiple channels of data communication. Further, in some arrangements, the network interface circuit 124 includes cryptography capabilities to establish a secure or relatively secure communication session in which data communicated over the session is encrypted (e.g., encrypted, then communicated over the network, and then decrypted by the receiving party).

The processing circuit 126 includes a memory 128 and a processor 130. The memory 128 may be one or more devices (e.g., RAM, ROM, Flash memory, hard disk storage) for storing data and/or computer code for completing and/or facilitating the various processes described herein. Memory 128 may be or include non-transient volatile memory, non-volatile memory, and non-transitory computer storage media. Memory 128 may include database components, object code components, script components, or other types of information structured for supporting the various activities and information structures described herein. The memory 128 may be coupled to the processor 130 and include computer code or instructions for executing one or more processes described herein. The processor 130 may be implemented as one or more server processors, application specific integrated circuits (ASIC), field programmable gate arrays (FPGAs), digital signal processor (DSP), microprocessors, or other suitable electronic processing components. The server(s) or server computer may be geographically dispersed relative to other server(s) of the rewards platform computing system 122. Further, there may be a variety of different types of server(s) included in the computing system 122 (e.g., application server, database server, catalog sever, virtual private network (VPN) server, communications server, web server, and so on). The memory device may be included with the server(s). The rewards platform computing system 122 is structured to run a variety of application programs and store associated data in a database of the memory 128.

The rewards platform computing system 122 further includes a token generator circuit 132. The token generator circuit 132 is structured to generate and/or otherwise create access tokens for a user 102 (e.g., Open Authentication, or OAuth tokens). The access tokens are used in a token-based authentication to allow a rewards provider computing system (e.g., rewards provider computing system(s) 150) to access an application programming interface (API) (e.g., via the access circuit 138, as described further below) of the rewards platform computing system 122. Furthermore, the token generator circuit 132 is structured to generate access tokens which associatively map to both an expiration (e.g., a lifespan for the access token contained in the token repository 144) and a set of user preferences (e.g., in the user preferences repository 146 as further described below, with particular reference to FIGS. 2 and 3). In an exemplary embodiment, the access tokens are opaque access tokens. That is, in such an embodiment, the access tokens are proprietarily formatted by the rewards platform computing system 122 such that they contain no inherent identifying data of a user (e.g., the user 102). Rather, such opaque tokens contain some identifier to information in a server's persistent storage (e.g., a persistent storage of the rewards platform computing system 122, such as the token and/or user preferences repository 146). The identifier may be a memory pointer, a database pointer, or any other identifier that may be modulated, or mapped to (e.g., associatively mapped via a data structure), by the rewards platform computing system 122 in order to access data of the user 102. In other embodiments, the access token may not be opaque, and may instead be an encrypted token directly containing the data of the user 102 (e.g., such as exemplified by a JSON Web Token (JWT)).

In some embodiments, the rewards platform computing system 122 facilitates communications between the rewards platform 120, user devices 104, and rewards provider computing systems 150 using an Open Authorization (OAuth) protocol. OAuth is a standard for token-based authentication and authorization on the Internet. OAuth is used for access delegation and may be used as a way for internet users to grant websites or applications access to their information on other websites or applications without giving them their passwords. In the context of the present application, OAuth is used as a way for users to grant the rewards platform 120 access to their information (e.g., accrued rewards) on rewards provider computing systems 150 without giving the rewards platform 120 their passwords to each of the rewards provider computing systems 150.

For example, the token generator circuit 132 can generate OAuth authentication tokens for a user 102 that identifies the user to the rewards provider computing systems 150. In this way, OAuth can be used to obtain rewards data of the user from various rewards provider computing systems 150. As such, the relationship between the rewards platform 120 and the rewards provider computing systems 150 can be created using the OAuth protocol, although as disclosed herein, other suitable credential tokenization/authorization protocols can be used. In this way, the user can bind a rewards provider via the rewards provider computing systems 150 to the rewards platform computing system 122 such that all rewards accumulated by the user at the provider can be automatically transferred to the rewards platform 120.

The security circuit 134 is structured to authenticate users (e.g., the user 102) accessing the system in order to configure rewards collection and allocation preferences (e.g., via the interface circuit 136, as described further below). The user 102 may authenticate with the rewards platform computing system 122 via a variety of modalities input into the client application 114 (or a web-based version of the client application 114, as described above), such as via a password, a fingerprint scan, a retinal scan, a voice sample, a face scan, and/or any other type of biometric security scan. Furthermore, the security circuit 134 is structured to verify a supplemental authentication when applicable (e.g., a two-factor authentication (2FA) presented on the user device 104 via the client application 114). The supplemental authentication may occur as part of a process to authorize a rewards provider (e.g., the rewards provider computing system(s) 150) to access data of the user 102 (e.g., such as discussed below, with reference to FIGS. 2 and 3). Additionally, the security circuit 134 is structured to authenticate rewards provider computing system(s) 150 (e.g., subsequent to receiving an API call, via the access circuit 138, as discussed below). The security circuit 134 may authenticate the rewards provider computing system(s) 150 according to credentials contained in the JSON body of the API call, such as an API token that uniquely identifies the rewards provider in the token repository 144 (e.g., provisioned by the rewards platform computing system 122 to the rewards provider computing system(s) 150).

Still referring to FIG. 1, the rewards platform computing system 122 further includes an interface circuit 136. The interface circuit 136 is structured to generate, compile, and otherwise create computer code executable on a processor of a user device (e.g., the user device 104), which when executed, creates user-interactive user interfaces (e.g., as part of a data sharing and permission settings process, as described further herein). For example, the interface circuit 136 may generate a user interface that enables a user (e.g., the user 102) to register for a rewards account and enter user preferences and allocations for managing the rewards account (e.g., as described further below, with reference to FIGS. 2 and 3). The user interface may then be provided to the user 102 via the client application 114 (e.g., over the network 118).

The access circuit 138 is structured to initiate, receive, process, and respond to API calls (e.g., over the network 118). That is, the access circuit 138 is the access point (e.g., such as a webserver) between the rewards platform computing system 122 and the rewards provider computing system(s) 150. Accordingly, in order to process the various API calls, the access circuit 138 delegates specific tasks to the other circuits. For example, user logins are delegated to the security circuit 134 and access token creation is delegated to the token generator circuit 132. Additionally, the access circuit 138 is structured to receive communication (e.g., API calls) from the interface circuit 136, which captures inputs of the user 102. That is, the interface circuit 136 may communicate selections of the user 102 to the rewards platform computing system 122 via the access circuit 138. Therefore, the access circuit 138 is communicatively coupled to the other circuits of the rewards platform computing system 122, either tangibly via hardware, or indirectly via software.

The data management circuit 140 is structured to handle a wide variety of tasks associated with the collection, analysis, aggregation, and allocation of rewards points. The data management circuit 140 is structured to collect rewards points and purchase data about the user 102 from any financial accounts associated with the rewards platform 120, and also from rewards provider computing system(s) 150, such as points of sale (including online stores and purchases). The data management circuit 140 may utilize web scraping algorithms and image recognition logic to pull and aggregate rewards data of the user 102 into the user data repository 148. Rewards data refers to user purchase and/or transaction data or an amount of rewards earned (e.g., points, money, cryptocurrency, non-fungible tokens) from one or more rewards providers which may be used to determine rewards points for the user on the rewards platform 120. In some embodiments the rewards data may be provided by the rewards providers directly in the form of rewards points. For example, a rewards provider may directly send how many rewards points a user has collected from the rewards provider. In other embodiments, the rewards data may be transaction data which may be used to determine rewards points associated with the transaction and/or purchase. For example, a rewards provider may send a purchase amount. From the purchase amount, the rewards platform computing system 122 may be able to determine the rewards points corresponding with the purchase amount. Furthermore, the data management circuit 140 may then analyze and allocate the rewards points determined from the user data into categories. For example, the data management circuit 140 may parse the user data (including the received updates, as further described in FIG. 2) in order to determine updated rewards data as the user continues to make purchases. That is, the data management circuit 140 may analyze (e.g., via any suitable data analysis or natural language processing technique) various data, such as search history, browsing history, image posting, file uploads/downloads (including metadata), transaction history, and location history (e.g., of the user 102), and subsequently, associatively store them with categorical descriptors (e.g., in the user data repository 148). The data management circuit 140 is further structured to process all rewards allocation and management related tasks. That is, the data management circuit 140 is structured to: receive rewards data for one or more rewards providers (e.g., from the rewards computing system), calculate and process rewards or funds due to the user 102, and display the aggregation and allocation of the rewards or funds due to the user 102 through a user interface on the user device 104.

In some embodiments, the data management circuit 140 may determine an amount of rewards to allocate to the user based on transactions performed by the user. For example, the data management circuit 140 can track the user's usage of other applications associated with the rewards platform 120 and provide rewards based on the usage. For example, the data management circuit 140 can receive data from a payment or transaction application, such as Zelle™, and provide rewards to the user based on the user registering for Zelle™, conducting a threshold number of transactions using Zelle™ (e.g., 1 transaction, 5 transactions, etc.), using certain features of Zelle™ such as sending or receiving funds using a QR code, adding friends to the user's account, tagging friends in fund transfers, and so on.

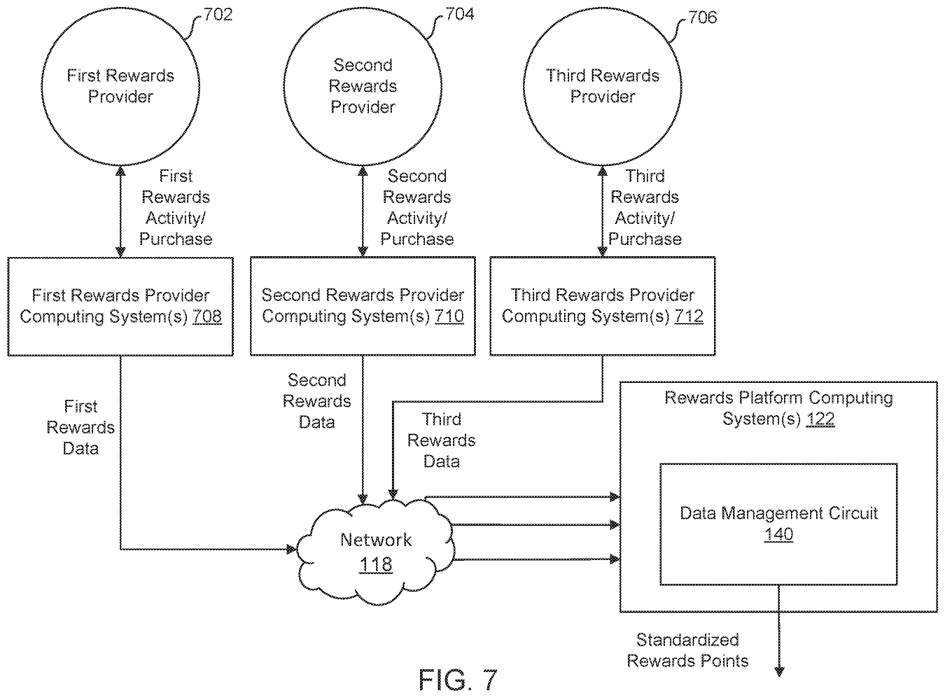

The data management circuit 140 may also be configured to convert rewards data received from the rewards provider computing system into a standardized rewards point format. The rewards data received may be from multiple different rewards providers. Hence, the rewards data received may come in different forms that are associated with different monetary values. For example, airline points from a major airline may have a different monetary value than loyalty points from a regional grocery store or online retailer when compared on a one-to-one ratio. Therefore the data management circuit 140 converts the rewards data (e.g., point amount, monetary value of each point, etc.) received from each different rewards provider into a standardized rewards points format. For example, as shown in FIG. 7, a system for converting rewards data from different rewards is shown according to an exemplary embodiment. One or more rewards providers (e.g., a first rewards provider 702, a second rewards provider 704, and a third rewards provider 706) may provide rewards data to a respective rewards provider computing system (e.g., a first rewards provider computing system 708, a second rewards provider computing system 710, and a third rewards provider computing system 712), similar to the rewards provider computing system 150. In some embodiments, the rewards data may be in the form of rewards points associated with the rewards provider or in the form of a monetary value. The rewards providers 702, 704, and 706 may be any business which provides consumers rewards points in exchange for the payment of goods or services. For example, the rewards providers 702, 704, and 706 may be retailers, airlines, hotels, restaurants, salons, banks, or any similar consumer business. The rewards provider computing systems 708, 710, 712 may collect, calculate, and store the rewards data associated with the one or more rewards providers 702, 704, and 706 and send the rewards data over the network 118 to the rewards platform computing system 122. Specifically, the rewards data may be provided to the data management circuit 140 which converts the rewards data received from the rewards provider into a standardized rewards points, as disclosed further herein.

The data management circuit 140 is further structured to implement a payments engine of the rewards platform computing system 122. The payments engine utilizes a payment logic of the rewards platform computing system 122 in order to determine, verify, and process any rewards or funds due to the user 102. That is, the payments engine may determine, verify, and process an amount of funds due to the user 102 according to any applicable agreements in place between a rewards provider and the user 102. In some embodiments, the payments engine may additionally determine, verify, and process an amount of funds due to a user 102 according to one or more agreements between the user and the rewards platform which collects, aggregates, and allocates the rewards from the rewards providers. For example, the user 102 may have an agreement in place with a rewards provider that dictates that the rewards provider is to provide rewards to the user 102 in the amount of $0.02 for each standardized rewards point earned. Accordingly, in an example where the user 102 has earned 100 rewards points, the payments engine may calculate that the user 102 is due funds in the amount of 2 dollars (e.g., 100 multiplied by the agreed-upon value of $0.02 each). As a further example, the rewards platform 120 may have an agreement in place with a user that dictates that the rewards platform is to provide rewards to the user 102 in the amount of $0.01 for each standardized rewards point earned. Accordingly, in an example where the rewards platform 120 has aggregated 100 rewards points associated with the, the payments engine may calculate that the user 102 is due funds in the amount of 1 dollar (e.g., 100 multiplied by the agreed-upon value of $0.01 each). In examples where the rewards provider provides a tabulation of funds due, the payments engine may verify the rewards provider tabulation in a similar manner (e.g., prior to processing a payment for the user 102). Furthermore, the payments engine is configured to process payments (e.g., by an API call, via the access circuit 138) for the user 102. That is, the payments engine may initiate an API call to deduct funds from an account of the rewards provider(s) or the rewards platform 120 and transfer funds to the user 102. In embodiments where the user 102 has a financial account with the rewards platform 120, the payments engine may directly credit the account of the user 102 in the amount of the funds due. In some embodiments, the financial account may be one of at least a checking account, a savings account, an investment account (e.g., mutual fund investment account, custodial accounts under the Uniform Gifts to Minors Act, stock in an entity associated with the rewards platform 120), and/or a cryptocurrency account. In some embodiments, the user 102 may set a preference on how to allocate the rewards points. For example, the user 102 may allocate half their rewards points to a checking account and the other half to a cryptocurrency account, or to a gasoline bankcard.

The input/output circuit 142 of the rewards platform computing system 122 is structured to exchange data, communications, instructions, etc. with an input/output component of the rewards platform computing system 122 (e.g., a keyboard, a mouse, etc.) (e.g., with a rewards platform 120 employee, non-employee, operator, etc.). In one embodiment, the input/output circuit 142 is incorporated into an input/output device. For example, a mobile device, a smartphone, a laptop, desktop, or tablet computer may include the input/output circuit 142 such that the mobile device, the smartphone, the laptop, desktop, or tablet computer is communicably coupled to the rewards platform computing system 122. The input/output circuit 142 is structured to receive communications from, and provide communications to, various rewards platform 120 employees, agents, or operators associated with the rewards platform computing system 122.

The token repository 144 is configured to retrievably hold (e.g., in cache memory), store (e.g., in non-transitory memory), categorize, and/or otherwise serve as a repository for information pertaining to access tokens, configuration option(s) associated with the access tokens (e.g., an expiration), users (e.g., associatively mapping the access tokens to a user), and API tokens provisioned to rewards providers. Accordingly, the token repository 144 is configured to retrievably store and access information pertaining to access rights of the rewards platform (e.g., access to the rewards provider computing system 150).

The user preferences repository 146 is configured to retrievably hold (e.g., in cache memory), store (e.g., in non-transitory memory), categorize, and/or otherwise serve as a repository for information pertaining to permission settings of the user 102 (e.g., rewards provider designations for data sharing, the subsets of the data to share, advertising preferences and arrangements, and any such settings associated with a dependent of the user 102).

The user data repository 148 is configured to retrievably hold (e.g., in cache memory), store (e.g., in non-transitory memory), categorize, and/or otherwise serve as a repository for information pertaining to the data of the user 102. That is, the user data repository 148 serves as the central aggregation point for all of the categorized data of the user 102. Accordingly, the user data repository 148 may retrievably store data of the user 102 that has been collected from, among other sources, a plurality of rewards providers (e.g., as discussed further herein, with reference to FIGS. 2 and 3).

The rewards points repository 149 is configured to retrievably hold (e.g., in cache memory), store (e.g., in non-transitory memory), categorize, and/or otherwise serve as a repository for information pertaining to the rewards data. That is, the rewards points repository 149 serves as the central aggregation point for all of the allocated rewards points. Accordingly, rewards points repository 149 may retrievably store data of the user 102 that has been collected from, among other sources, a plurality of rewards providers (e.g., as discussed further herein, with reference to FIGS. 2 and 3).

Still referring to FIG. 1, the rewards collection and aggregation computing system 100 further includes a rewards provider computing system(s) 150. As depicted, the rewards provider computing system(s) 150 is a backend computer system. The rewards provider computing system(s) 150 may be implemented using a computing system, such as a discrete server, a group of two or more computing devices/servers, a distributed computing network, a cloud computing network, and/or another type of computing system capable of accessing and communicating using local and/or global networks (e.g., the network 118). For example, in some embodiments, the provider computing system(s) 150 may be a webserver.

The rewards provider computing system(s) 150 includes a network interface circuit 152, a processing circuit 154, and an input/output circuit 160. The network interface circuit 152 is structured to establish communicable connections with other computing systems (e.g., the user device 104, the rewards platform computing system 122, other computing systems, etc.), by way of the network 118. The network interface circuit 152 may include program logic that facilitates connection of the rewards provider computing system(s) 150 to the network 118. For example, the network interface circuit 152 may include a combination of a wireless network transceivers (e.g., a NFC transceiver, a Bluetooth transceiver, a Wi-Fi transceiver, etc.) and/or a wired network transceiver (e.g., an Ethernet transceiver). In some arrangements, the network interface circuit 152 includes the hardware and machine-readable media sufficient to support communication over multiple channels of data communication. Further, in some arrangements, the network interface circuit 152 includes cryptography capabilities to establish a secure or relatively secure communication session in which data communicated over the session is encrypted.

The processing circuit 154 includes a memory 156 and a processor 158. The memory 156 may be one or more devices (e.g., RAM, ROM, Flash memory, hard disk storage) for storing data and/or computer code for completing and/or facilitating the various processes described herein. Memory 156 may be or include non-transient volatile memory, non-volatile memory, and non-transitory computer storage media. Memory 156 may include database components, object code components, script components, or other types of information structured for supporting the various activities and information structures described herein. The memory 156 may be coupled to the processor 158 and include computer code or instructions for executing one or more processes described herein. The processor 158 may be implemented as one or more server processors, application specific integrated circuits (ASIC), field programmable gate arrays (FPGAs), digital signal processor (DSP), microprocessors, or other suitable electronic processing components. Further, there may be a variety of different types of server(s) included in the rewards provider computing system(s) 150 (e.g., application server, database server, communications server, web server, and so on). The memory device may be included with the server(s). The rewards provider computing system(s) 150 is structured to run a variety of application programs and store associated data in a database of the memory 156.

The input/output circuit 160 of the rewards provider computing system(s) 150 is structured to exchange data, communications, instructions, etc. with an input/output component of the rewards provider computing system(s) 150 (e.g., a keyboard, a mouse, etc.) (e.g., with a rewards provider employee, non-employee, operator, etc.). In one embodiment, the input/output circuit 160 is incorporated into an input/output device. For example, a mobile device, a smartphone, a laptop, desktop, or tablet computer may include the input/output circuit 160 such that the mobile device, the smartphone, the laptop, desktop, or tablet computer is communicably coupled to the rewards provider computing system(s) 150. The input/output circuit 160 is structured to receive communications from, and provide communications to, various rewards provider employees, agents, or operators associated with the rewards provider.

In some embodiments, the rewards provider computing systems 150 may be associated with a provider of rewards, such as a merchant, financial institution, or a third party entity such as an entity that tracks healthy living. For example, the rewards provider computing system 150 can be associated with a merchant or service provider that tracks purchases made by a user and allocates rewards or rewards points to a user account that can be redeemed by the user at the merchant or service provider, or once bound to the rewards platform 120, aggregated with rewards from other rewards providers and redeemed by the user at the rewards provider or via the rewards platform 120. In some embodiments, provider computing systems 150 may be associated with a third party, such as an entity that tracks healthy living (e.g., a healthy eating or weight loss program). In this example, the healthy living entity may provide data to the rewards platform computing system 122 regarding a healthy living activity of the user, such as an amount of weight lost over a time period, a caloric deficit achieved during a time period, or a number of healthy meals consumed. The rewards platform computing system 122 may allocate rewards to the user based on such data.

In some embodiments, the rewards platform computing system 122 enables the user to redeem aggregated rewards points via the rewards providers participating in the aggregation system that are bound by the user to the rewards platform. For example, the rewards platform computing system 122 may aggregates rewards earned by the user at a plurality of rewards providers, and enable the user to make a purchase from one of the rewards providers of the plurality of rewards providers via the rewards platform computing system 122. To facilitate such a transaction, the rewards platform computing system 122 may display a user interface on the user device listing an offer or advertisement from one or more of the rewards providers of the plurality of rewards providers or provide a listing of products being offered for sale by one or more of the rewards providers of the plurality of rewards providers through the rewards platform 120. The rewards platform computing system 122 may redirect the user to a website or application of the one or more of the rewards providers of the plurality of rewards providers to make the purchase with their aggregated rewards points aggregated by the rewards platform 120 or enable the purchase to be made via the rewards platform 120.

Referring now to FIG. 2, a flow diagram of a method 200 for collecting and allocating rewards points data for a user from one or more rewards providers is shown, according to an example embodiment. That is, method 200 describes the rewards data collection and aggregation process in detail (e.g., between the rewards platform computing system 122 and the rewards provider computing systems 150), including real-time data collection as the user 102 continues to make purchases. The process 200 may be implemented to collect data from multiple rewards providers concurrently. Hence, the rewards platform computing system 122 may collect and combine the rewards points earned from multiple different rewards providers under one rewards accounts. Method 200 may be performed using the system of FIG. 1 such that reference is made to the components of FIG. 1 to aid the description of method 200.

The method 200 begins at process 202 with the rewards platform computing system 122 receiving an input from the user 102 that identifies a rewards provider for rewards data collection (e.g., via an API call, by the client application 114). For example, the rewards platform computing system 122 may receive the input when the user 102 makes a purchase at a point of sale (POS). As another example, the rewards platform computing system 122 may receive the input when the user 102 logs into their rewards account through a user interface. The input may be any variety of selections made by the user 102 via the user interface of the client application 114 (e.g., a drop-down box, a button, a highlighted row, etc.) and transmitted over the network 118. It should be appreciated that process 202 presupposes an authenticated user-session in order to access the client application 114. Any such required authentication may be completed via the security circuit 134 prior to accessing the client application 114 (e.g., via password, biometric scan, etc., as described above with reference to FIG. 1).

Furthermore, it should be appreciated that the user 102 selection of a rewards provider to share and receive data with is a real-time updating processes and one that may occur at any point (e.g., in the methods 200 and 300). That is, at any point during use of the systems and methods described herein, the user 102 may access the graphical user interface (e.g., via the client application 114) and enable and disable rewards data collection with one or more rewards providers (e.g., or with all rewards providers, such as via a toggle generated by the interface circuit 136).

At process 204, the rewards platform computing system 122 provides (e.g., via the interface circuit 136 over the network 118) selectable rewards allocation categories that classify subsets of the rewards points earned by the user 102 (e.g., according to a classification scheme) into one or more rewards allocation categories. That is, the rewards platform computing system 122 may first gather (e.g., as described further in FIG. 3) and aggregate all the rewards points data of the user 102 that it contains in the user data repository 148. The rewards platform computing system 122 then classifies the rewards points for the user into rewards points subsets according to a classification scheme. The classification scheme provides a set of rules or logical expression that enable various parties (e.g., the rewards platform 120 and the rewards providers) to assign rewards points to rewards points categories in a consistent manner. More specifically, the rewards platform 120 may analyze one or more purchases made by user 102 that earn rewards points to determine the classification of the rewards points. For example, if the user 102 purchases a plane ticket and earns 1000 rewards points as a result, the rewards platform 120 may classify those rewards points into a travel rewards points category. Furthermore, the classification scheme may provide rules for classification at various levels of granularity. For example, a high level classification may be travel rewards points, which may then be further broken down into further layers of sub-classifications (e.g., based on hotel rewards points, airline rewards points, transportation rewards points, rewards points accrued through specific companies, etc.). In some embodiments, the classification scheme may be provided by the rewards platform 120. In some embodiments, the classification scheme may be provided by a rewards provider or a third party. Accordingly, the classification scheme utilized may be agreed upon by the rewards platform 120 and one or more rewards providers prior to use (e.g., such as during an initial contract negotiation). In some embodiments, the classification scheme may be subject to change (e.g., dynamically with regulation changes, user preference changes, etc.) and decided on a per-use basis (e.g., via an API call).

It should be appreciated that the rewards point categories are not limited by the examples provided herein, but rather, are subject to dynamic change at the discretion of the rewards platform 120. In some embodiments, the rewards platform computing system 122 may generate data categories in response to current events. For example, during a holiday season, the rewards platform computing system 122 may generate and provide a category representing the rewards points earned from holiday shopping/purchases (e.g., a holiday shopping category). Moreover, in some embodiments, the rewards platform computing system 122 may periodically communicate (e.g., an API call via the access circuit 138) with a rewards provider computing system 150 for current events and updates (in order to generate and provide up-to-date categories at all times). Furthermore, in yet another embodiment, the user 102 may create categories of their own and subsequently assign rewards points to them (e.g., via the client application 114). As an example, the rewards platform computing system 122 may categorize a subset of rewards points as pertaining to restaurants and entertainment; however, the user 102 may wish to further narrow such a subset and re-classify the rewards points into a fine dining and casual dining. In such a scenario, the user 102 may either manually assign rewards points (e.g., via the client application 114) into the new categories or rely on the predictive logic of the interface circuit 136 to assign data into the respective categories (e.g., all rewards points pertaining to fine dining may be predictively assigned). Accordingly, the classification scheme employed by the various parties to assign data to such categories may be updated in response to any data category changes (e.g., where applicable).

At process 206, the user 102 selects (e.g., via a selectable icon such as a checkbox, presented via the client application 114) at least one rewards point category from the provided rewards points categories for receiving rewards data from an identified rewards provider (e.g., a restaurant or chain of restaurants, a store or chain of stores, a service provider such as an airline or cellular service company, etc.). That is, the user 102 makes a decision to collect all the rewards points from the selected categories from the identified rewards provider. For example, the user 102 may decide to collect all rewards points earned from shopping and dining purchases from shopping and dining rewards providers (e.g., restaurants and stores) while refraining from collecting rewards points earned from travel purchases. Additionally, in an exemplary embodiment, the user 102 may be presented with a checkbox or other selectable icon (e.g., via the client application 114) that allows the user 102 to select all the potential categories on a user interface. The client application 114 then transmits the selections of the user 102 to the rewards platform computing system 122 (e.g., via an API call over the network 118). Accordingly, at the conclusion of process 206, the user 102 has identified one or more rewards providers and at least one rewards points category from which the user 102 desires to collect rewards points.

At process 208, the rewards platform computing system 122 receives the selection of rewards points categories from the user 102 and subsequently determines a set of rewards points categories (e.g., according to the classification scheme) applicable to the identified rewards providers (e.g., restaurants, stores, businesses, banks, etc.). In one embodiment, the rewards platform computing system 122 may receive periodic (e.g., daily, weekly, monthly, etc.) updates from cooperating rewards providers that identify the rewards points categories currently utilized. In an exemplary embodiment, the rewards platform computing system 122 may communicate in real-time with a rewards provider computing system 150 associated with the identified rewards provider. In such an embodiment, the rewards platform computing system 122 may formulate a GET request, for example, and transmit it over the network 118, via the access circuit 138 (e.g., communicating via application programming interfaces (APIs)). The GET request being structured to get a real-time list of the applicable rewards points categories of the identified rewards provider. In response, the rewards platform computing system 122 receives a real-time list of the applicable rewards provider rewards points categories (e.g., formatted in JavaScript Object Notation (JSON)). The rewards platform computing system 122 may then parse the JSON response and derive a text-based list of the applicable rewards points categories (e.g., based on the rules defined in the classification scheme).

At process 210, the rewards provider computing system 150 may be structured to collect user rewards data. The rewards provider computing system 150 is configured to receive user rewards data from one or more rewards providers. Once the rewards provider computing system 150 receives the user rewards data from the rewards providers, the rewards provider computing system 150 collects the user rewards data and stores the user rewards data in the memory 156.

At process 212, the rewards provider computing system 150 provides the user rewards data to the rewards platform computing system 122. It will be appreciated that in some embodiments, the rewards platform computing system 122 may not store the aggregated data of the user 102. Rather, in some embodiments, the rewards platform computing system 122 may instead make an API call(s) to all eligible rewards providers participating in the service of the rewards platform 120, which requests the applicable rewards contained locally by each rewards provider. Accordingly, in such embodiments, the rewards provider computing system 150 may then aggregate the rewards points of the user 102 as determined by the rewards data of the user 102 in real-time (e.g., at the same time as the API call(s) return with responses), process it via the rules engine (e.g., of the data management circuit 140, as discussed further herein), and ultimately aggregate the applicable rewards data (e.g., the data after rules have been applied) of the user 102 without storing it or only temporarily storing it. In some embodiments, the rewards platform computing system 122 stores the user rewards data until the user 102 decides to cash out the rewards points. When the user 102 cashes out the rewards points, the rewards platform computing system 122 allocates the rewards points to whichever account(s) is chosen by the system. For example, if the user 102 selects a cryptocurrency account, or if the rewards platform computing system automatically and predictively selects a cryptocurrency account, to cash out the rewards point, the rewards provider computing system 150 converts the rewards points to their respective cryptocurrency amount and then sends that data to the rewards platform computing system 122 to allocate to the associated cryptocurrency account of the user. In some embodiments, the rewards platform computing system 122 establishes an appropriate cryptocurrency account for the user if the user does not already have such an account associated with their user account. At process 214, the rewards provider computing system 150, provides the rewards data of the user 102 as identified by the access token (e.g., as associatively mapped to in the permissions repository 146). It will be appreciated that in some embodiments, the rewards platform computing system 122 may not store the aggregated data of the user 102 (e.g., in order to provide to a rewards provider in response to a data access request). Rather, in some embodiments, the rewards platform computing system 122 may instead make an API call(s) to all eligible rewards providers participating in the service of the rewards platform 120, which requests the applicable rewards contained locally by each rewards provider. Accordingly, in such embodiments, the rewards provider computing system 150 may then aggregate the rewards points of the user 102 as determined by the rewards data of the user 102 in real-time (e.g., at the same time as the API call(s) return with responses), process it via the rules engine (e.g., of the data management circuit 140, as discussed further herein), and ultimately provide aggregated applicable rewards data (e.g., the data after rules have been applied) of the user 102 without storing it or only temporarily storing it. At process 214, the rewards platform computing system 122 receives the rewards data associated with the API call made. The rewards platform may then use that rewards data to determine rewards points for the user based on the received rewards data for the user (e.g., as described in the data conversion process 216). Furthermore, the rewards provider may also make additional API calls to access other information of the user 102 (e.g., as dictated by the permission settings), and to further refine the information they are receiving (e.g., as discussed above). Any additional API calls made by the rewards platform computing system 122 may follow the same processes.

At process 216, the rewards platform computing system 122 converts the user rewards data received at process 214 into a standardized rewards point format. As explained above, the rewards data received may be from multiple different rewards providers. Hence, the rewards data received may come in different forms that are associated with different monetary values. For example, airline points from a major airline may have a different monetary value than loyalty points from a local gas station when compared on a one-to-one ratio. Therefore, at process 216, the rewards platform computing system 122 converts the rewards data (e.g., point amount, monetary value of each point, etc.) received from the rewards provider into a standardized rewards points format. In some embodiments, the conversion rate for converting between rewards points and an actual cash amount is predetermined and that it may be based on contractual agreements between one or more rewards providers and the rewards platform computing system 122. In some embodiments, the contractual agreement may specify that rewards points received from a specific rewards provider may have a higher or lower monetary value once transferred from the rewards provider computing system 150 to the rewards platform computing system 122 than their monetary value on the rewards provider computing system 150. Once converted to the standardized rewards points format, the rewards data may then have an associated monetary value. For example, one standardized rewards point as determined by the rewards platform computing system may equal $0.03. The process 216 may be repeated as often as the rewards platform computing system continues to receive rewards data from different rewards providers. It will be appreciated that a rewards point or rewards cash amount from a first particular rewards provider may be worth a greater amount, a lesser amount, or the same amount as a rewards point on the rewards platform 120, while a rewards point or rewards cash amount from a second particular rewards provider may be worth a different amount than the rewards point or cash amount of the first particular rewards provider.

Accordingly, at process 218, the rewards platform computing system 122 aggregates the standardized rewards points determined at process 216 under one rewards account for the user 102. As mentioned above, the method 200, and specifically, the processes 210 to 222 may be continually repeated as the user 102 continues to purchase and earn rewards points from rewards providers. Therefore, as the processes 210 to 222 repeats, the rewards platform computing system 122 will continue to aggregate standardized rewards points for a user under one rewards account. The aggregated rewards points for the user 102 may be stored in the rewards point repository 149 and allocated as appropriate, as disclosed further herein.

At process 220, the rewards platform computing system 122 allocates the aggregated standardized rewards points to one or more financial accounts or redeems rewards points based on the user allocation preferences as determined at step 206 or based on a user input. More specifically, the standardized rewards points have an associated monetary value. Thus, when the user 102 sends an indication to the platform computing system 122 that they ready to “cash out” their standardized rewards points (e.g., convert the standardized rewards points to currency), the rewards platform computing system 122 may convert the standardized rewards points to a cash amount and then allocate that cash amount to one or more financial accounts based on the user allocation preferences submitted at step 206. For example, the user may wish to cash into one of a checking account, savings account, investment account, or cryptocurrency account. Once the rewards points have been allocated, the user device 104 displays the allocated rewards to the user 102 (e.g., via the client application 114) that allows the user 102 to see their rewards points allocations on a user interface. In some embodiments, the rewards platform computing system 122 may store the rewards points as opposed to immediately allocating the rewards points until the user decides to cash out or redeem the rewards points. In that case, the rewards platform computing system 120 would allocate the rewards to the users desired account (e.g., a checking account) when the user decides to redeem the rewards points. In other embodiments, the rewards platform computing system 122 may separate the rewards points collected into a first category and a second category, wherein the rewards platform computing system may automatically allocate the rewards points in the first category and requests feedback from the user to manually allocate the rewards points in the second category. For example, points collected from certain retailers (e.g., airlines and hotels) may be automatically allocated while points collected from other retailers (e.g., grocery stores, clothing stores, etc.) may be manually allocated.

In some embodiments, the “cash out” value of rewards points is based on the allocation of the rewards points such that different methods of redeeming the aggregated rewards points results in the user receiving a greater or lesser value rewards points than if the user selected a baseline “cash out” option (e.g., redeeming rewards points as a checking account or savings account deposit). For example, the rewards platform computing system 122 can provide the user with $100 worth of a particular cryptocurrency (e.g., Bitcoin, Ethereum, Dogecoin) for 100 aggregated rewards points whereas, and for the same 100 aggregated rewards points, the rewards platform computing system 122 would only provide the user with $80 of a savings account or checking account, or the rewards platform computing system 122 would provide the user with $110 worth of gift cards from a particular merchant. In some embodiments, the rewards platform computing system 122 provides a greater “cash out” value of rewards points if the user enables the rewards platform computing system 122 to automatically allocate aggregated rewards points a certain way. For example, the rewards platform computing system 122 can provide the user with $100 worth of a particular cryptocurrency (e.g., Bitcoin, Ethereum, Dogecoin) for 100 aggregated rewards points for a manual redemption of the 100 aggregated rewards points, whereas if the user has an enabled the rewards platform computing system 122 to automatically allocated aggregated rewards points to obtain a particular cryptocurrency, the rewards platform computing system 122 provides the user with $110 of the particular cryptocurrency on an automatic and reoccurring basis. The rewards platform computing system 122 can provide the user with greater tiers of rewards should a threshold amount of aggregated rewards be redeemed in a certain way. For example, the rewards platform computing system 122 can provide the user with $100 worth of a particular cryptocurrency (e.g., Bitcoin, Ethereum, Dogecoin) for the first 100 aggregated rewards points, but provide the user additional cryptocurrency once the user redeems more than 100 aggregated rewards points in a set time period (e.g., 1 year, 6 months, 3 months, etc.). For example, the rewards platform computing system 122 can provide the user with $100 worth of a particular cryptocurrency (e.g., Bitcoin, Ethereum, Dogecoin) for the first 100 aggregated rewards points in a calendar year, $110 worth of the same or a different cryptocurrency for the second 100 aggregated rewards points in the same calendar year, and $120 worth of the same or a different cryptocurrency for the second 100 aggregated rewards points in the same calendar year, and so on.

Referring now to FIG. 3, a flow diagram of a method 300 for rewards account creation and rewards data collections is shown, according to an example embodiment. That is, method 300 describes the rewards data collection process in detail (e.g., between the rewards platform computing system 122 and the rewards provider computing system 150), including real-time data collection as the user 102 continues to make purchases, as it relates to the rewards collection and allocation process. The process 300 may be implemented to receive rewards data from multiple rewards providers concurrently. Hence, the rewards platform computing system 122 may collect and combine the rewards points earned from multiple different rewards providers under one rewards accounts. Method 300 may be performed using the system of FIG. 1 such that reference is made to the components of FIG. 1 to aid the description of method 300.

The method 300 begins at process 302 with a first application programing interface (API) associated with the user device 104 receiving an user input received to configure a rewards wallet account setting. As explained above, a user may be associated with a rewards wallet account which collects and aggregates rewards points from one or more providers and stores them in a central location. At process 302, the settings of the rewards wallet account may be configured based on one or more inputs received from the user 102 through the user device 104. For example, the user 102 may be provided with a registration page which requests one or more inputs which may be used to configure the rewards wallet account. For example, the requested inputs may include an identifier for the user (e.g., name, date of birth, social security number, etc.), which rewards providers the user would like to collect rewards points from, and which accounts the user would like to allocate the rewards points to. As another example, the rewards platform computing system 122 may receive the input when the user 102 logs into their rewards account through a user interface. The input may be any variety of selections made by the user 102 via the user interface of the client application 114 (e.g., a drop-down box, a button, a highlighted row, etc.) and transmitted over the network 118. It should be appreciated that process 302 presupposes an authenticated user-session in order to access the client application 114. Any such required authentication may be completed via the security circuit 134 prior to accessing the client application 114 (e.g., via password, biometric scan, etc., as described above with reference to FIG. 1).

Furthermore, it should be appreciated that the user 102 selection of a rewards provider to share and receive data with is a real-time updating processes and one that may occur at any point. That is, at any point during use of the systems and methods described herein, the user 102 may access the graphical user interface (e.g., via the client application 114) and enable and disable rewards data collection with one or more rewards providers (e.g., or with all rewards providers, such as via a toggle generated by the interface circuit 136).

At process 304, a second API associated with the rewards provider computing system 150 generates a request for the rewards data of the user. The request generated by the second API may be in the form of an API which can be sent to one or more rewards providers to request rewards data from the user. More specifically, the rewards provider computing system 150 may generate and transmit an API call (e.g., a data sharing request) to the rewards providers. In some embodiments, the API call may contain a uniform resource locator (URL), thus creating the SSL encrypted window directly to an address to the rewards provider computing system 150, as well as an identifier of the rewards provider (e.g., in a JSON body of the call).

At process 306, the second API associated with the rewards provider computing system 150 receives, from the plurality of rewards providers, an API response containing the rewards data of the user. More specifically, the rewards provider computing system 150 receives the rewards data associated with the API call made in the previous process 304. The rewards platform may then use that rewards data to determine rewards points for the user based on the received rewards data for the user (e.g., as described in the data conversion process 308). Furthermore, the rewards provider may also make additional API calls to access other information of the user 102 (e.g., as dictated by the permission settings), and to further refine the information they are receiving (e.g., as discussed above). Any additional API calls made by the rewards platform computing system 122 may follow the same processes. The rewards data received by the second API may then be sent to the rewards platform computing system 122 for further processing as will be explained in more detail below with respect to processes 308-312.

At process 308, a third API associated with the rewards platform computing system 122 converts the data of the user gathered from each of the plurality of rewards providers into a standardized rewards format, where the standardized rewards format comprises standardized rewards points. As explained above, the rewards data received may be from multiple different rewards providers. Hence, the rewards data received may come in different forms that are associated with different monetary values. For example, airline points from a major airline can have a different monetary value than loyalty points from a local gas station when compared on a one-to-one ratio. Therefore, at process 308, the rewards platform computing system 122 converts the rewards data (e.g., point amount, monetary value of each point, etc.) received from the rewards provider into a standardized rewards points format. In some embodiments, the conversion rate for converting between rewards points and an actual cash amount is predetermined and that it may be based on contractual agreements between one or more rewards providers and the entity associated with the rewards platform 120. In some embodiments, the contractual agreement may specify that rewards points received from a rewards provider may have a higher or lower monetary value once moved from the rewards provider computing system 150 to the rewards platform computing system 122 than their monetary value on the rewards provider computing system 150. Once converted to the standardized rewards points format, the rewards data may then have an associated monetary value. For example, one standardized rewards point as determined by the rewards platform computing system may equal $0.03, though it will be appreciated that the value of one standardized rewards point can be any monetary or non-monetary amount. The process 216 may be repeated as often as the rewards platform computing system continues to receive rewards data from different rewards providers.

At process 310, the third API associated with the rewards platform computing system 122 aggregates the standardized rewards points determined at process 310 under one rewards account for the user 102. As mentioned above, the method 300, and specifically, the processes 304 to 312 may be continually repeated as the user 102 continues to purchases and earn rewards points from rewards providers. Therefore, as the processes 304 to 312 repeats, the rewards platform computing system 122 will continue to aggregate standardized rewards points for a user under one rewards account. The aggregated rewards points for the user 102 may be stored in the rewards point repository 149.

At process 312, the third API associated with the rewards platform computing system 122 allocates the aggregated standardized rewards points to one or more financial accounts or redeems rewards points based on the user allocation preferences based on a user input. More specifically, the standardized rewards points have an associated monetary value. Thus, when the user 102 sends an indication to the platform computing system 122 that they are ready to redeem or “cash out” their standardized rewards points (e.g., convert the standardized rewards points to currency), the rewards platform computing system 122 may convert the standardized rewards points to a cash amount and then allocate that cash amount to one or more financial accounts based on the user input. For example, the user may wish to add value into one of a checking account, savings account, investment account, or cryptocurrency account. Once the rewards points have been allocated, the user device 104 displays the allocated rewards to the user 102 (e.g., via the client application 114) that allows the user 102 to view their rewards points allocations on a user interface.

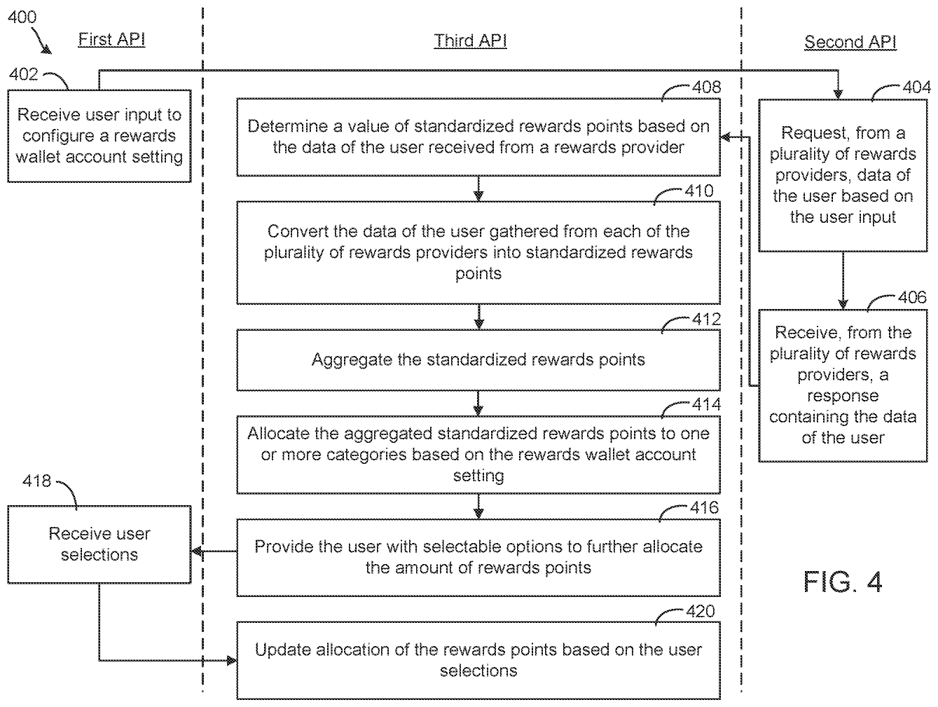

Referring now to FIG. 4, a flow diagram of a method 400 for rewards account creation and rewards data collections is shown, according to an example embodiment. That is, method 400 describes the rewards data collection process in detail (e.g., between the rewards platform computing system 122 and the rewards provider computing system 150), including real-time data collection as the user 102 continues to make purchases, as it relates to the rewards collection and allocation process. The process 400 may be implemented to receive rewards data from multiple rewards providers concurrently. Hence, the rewards platform computing system 122 may collect and combine the rewards points earned from multiple different rewards providers under one rewards accounts. Method 400 may be performed using the system of FIG. 1 such that reference is made to the components of FIG. 1 to aid the description of method 400.

The method 400 begins at process 402 with a first application programing interface (API) of the rewards platform computing system 122 receiving a user input via the user device 104 to configure a rewards wallet account setting. As explained above, a user may be associated with a rewards wallet account which collects and aggregates rewards points from one or more providers and stores them in a central location. At process 302, the settings of the rewards wallet account may be configured based on one or more inputs received from the user 102 through the user device 104. More specifically the input from the user 102 can identify a rewards provider for rewards data collection (e.g., via an API call, by the client application 114). For example, the rewards platform computing system 122 may receive the input when the user 102 makes a purchase at a POS. As another example, the rewards platform computing system 122 may receive the input when the user 102 logs into their rewards account through a user interface. The input may be any variety of selections made by the user 102 via the user interface of the client application 114 (e.g., a drop-down box, a button, a highlighted row, etc.) and transmitted over the network 118. It should be appreciated that process 402 presupposes an authenticated user-session in order to access the client application 114. Any such required authentication may be completed via the security circuit 134 prior to accessing the client application 114 (e.g., via password, biometric scan, etc., as described above with reference to FIG. 1).

Furthermore, it should be appreciated that the user selection of a rewards provider to share and receive data with is a real-time updating processes and one that may occur at any point. That is, at any point during use of the systems and methods described herein, the user 102 may access the graphical user interface (e.g., via the client application 114) and enable and disable rewards data collection with one or more rewards providers (e.g., or with all rewards providers, such as via a toggle generated by the interface circuit 136).

At process 404, a second API associated of the rewards platform computing system 122 generates a request for the rewards data of the user and provides the request to the rewards provider computing systems 150. More specifically, the rewards platform computing system 122 may generate and transmit an API call (e.g., a data sharing request) to the rewards provider computing systems 150. In some embodiments, the API call may contain a uniform resource locator (URL), thus creating an SSL encrypted window directly to the rewards provider computing system 150, as well as an identifier of the rewards platform 120 (e.g., in a JSON body of the call).

At process 406, the second API receives, from the plurality of rewards providers, an API response containing the rewards data of the user. More specifically, the rewards platform computing system 122 receives the rewards data associated with the API call made in the previous process 404. The rewards platform 120 may then use that rewards data to determine rewards points for the user based on the received rewards data for the user (e.g., as described in the data conversion process 410). Furthermore, the rewards platform computing system 122 may also make additional API calls to access other information of the user 102 (e.g., as dictated by the permission settings) stored by the rewards providers, and to further refine the information received from the rewards providers (e.g., as discussed above). Any additional API calls made by the rewards platform computing system 122 may follow the same processes. The rewards data received by the second API may then be further processed as will be explained in more detail below with respect to processes 408-418.

At process 408, the third API associated with the rewards platform computing system 122 determines a value of standardized rewards points based on the data of the user received from a rewards provider, for example, based on a predetermined transaction conversion rate. Each of the providers may have a contract or predetermined agreement regarding the conversion of rewards data (e.g., rewards points associated with a user) into standardized rewards points as recognized on the rewards platform. Based on this determination, the value of standardized rewards points can be determined. At process 410, the third API associated with the rewards platform computing system 122 converts the data of the user gathered from each of the plurality of rewards providers into a standardized rewards format, wherein the standardized rewards format comprises standardized rewards points.

At process 412, the third API associated with the rewards platform computing system 122 aggregates the standardized rewards points determined at process 410 under one rewards account for the user 102. As mentioned above, the method 400, and specifically, the processes 404 to 412 may be continually repeated as the user 102 continues to purchases and earn rewards points from rewards providers. Therefore, as the processes 404 to 412 repeats, the rewards platform computing system 122 continue to aggregate standardized rewards points for a user under one rewards account. The aggregated rewards points for the user 102 may be stored in the rewards point repository 149.

At process 416, the third API associated with the rewards platform computing system 122 allocates the aggregated standardized rewards points to one or more financial accounts or redeems rewards points based on the user allocation preferences based on a user input. More specifically, the standardized rewards points have an associated monetary value. Thus, when the user 102 sends an indication to the platform computing system 122 that they ready to “cash out” their standardized rewards points (e.g., convert the standardized rewards points to currency), the rewards platform computing system 122 may convert the standardized rewards points to a cash amount and then allocate that cash amount to one or more financial accounts based on the user input. For example, the user may wish to cash into one of a checking account, savings account, investment account, or cryptocurrency account. Once the rewards points have been allocated, the user device 104 displays the allocated rewards to the user 102 (e.g., via the client application 114) that allows the user 102 to see their rewards points allocations on a user interface.

At process 414, the third API allocates the aggregated standardized rewards points to one or more financial accounts or redeems rewards points based on the user allocation preferences based on a user input. More specifically, the standardized rewards points have an associated monetary value. Thus, when the user 102 sends an indication to the platform computing system 122 that they are ready to redeem or “cash out” their standardized rewards points (e.g., convert the standardized rewards points to currency), the rewards platform computing system 122 may convert the standardized rewards points to a cash amount and then allocate that cash amount to one or more financial accounts based on the user input. For example, the user may wish to add value into one of a checking account, savings account, investment account, or cryptocurrency account. Once the rewards points have been allocated, the user device 104 displays the allocated rewards to the user 102 (e.g., via the client application 114) that allows the user 102 to view their rewards points allocations on a user interface.

At process 416, the third API provides the user, via the user device 104 and the first API, with selectable options to further allocate the amount of rewards points. For example, a user may be able to choose different accounts to allocate the funds too and different portions to allocate the points. In this case, at process 418, the first API receives user selections to change or update the allocation of the rewards point. At process 420, the third API updates the allocation of the rewards points based on the user selections received at process 418.

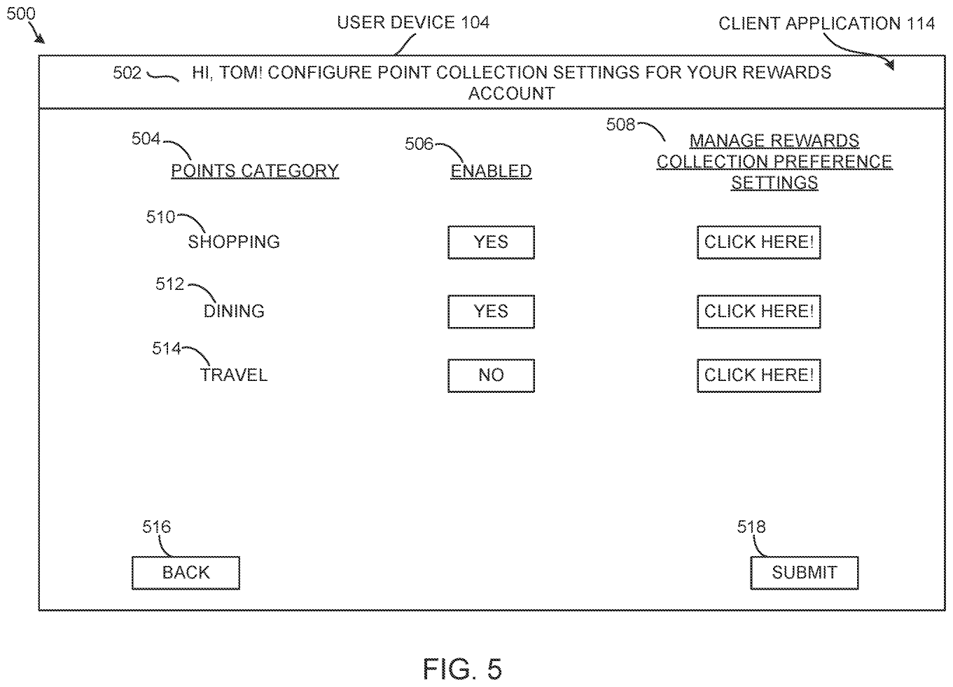

Referring now to FIG. 5, an illustrative example of a dynamic graphical user interface 500, displayed on the user device 104 as part of a data sharing process is shown, according to an example embodiment. In the depicted embodiment, the user device 104 includes a display showing the graphical user interface 500 (e.g., provided by the client application 114, via the interface circuit 136), which is structured to facilitate a user (e.g., the user 102) to configure rewards data collection for one or more identified rewards providers, as described in the method 200.

The user interface of 500 includes a title bar 502, section columns 504, 506, 508, section rows 510, 512, 514, a “BACK” button 516, and a “SUBMIT” button 518. The title bar 502 is depicted as a textual (e.g., string) display title, which informs the user as to the purpose of the display. The title bar 502 is structured to dynamically update (e.g., via the interface circuit 136, displayed by the client application 114) as the user 102 navigates around the client application 114. Accordingly, the title bar 502 informs the user 102 that the purpose of the graphical user interface 500 is to configure rewards data collection settings for a rewards account.

The section columns 504, 506, 508 are depicted as textual (e.g., string) column titles that identify the data held in the rows below them. For example, section column 504, “POINTS CATEGORY”, identifies the contents of the rows below as rewards points category labels. Section column 506, “ENABLED”, identifies the contents of the rows below as a selectable Boolean attribute (e.g., to enable/disable rewards data collection sharing from the associated rewards points category, with the rewards provider identified in the display title). Section column 508, “MANAGE REWARDS COLLECTION PREFERENCE SETTINGS” identifies the contents of the rows below as a selectable interaction point, which when selected brings the user 102 to a display (not depicted) that enables the user 102 to create more narrow subsets of the correlated rewards points category (e.g., such as described in processes 204 and 206).

Therefore, the section rows 510, 512, 514 represent an operative view of each data category, as it pertains to its enablement and structure. That is, in the depicted example, each row contains a data category label (e.g., string), a Boolean selectable toggle (e.g., a button as depicted), and a selectable interaction point (e.g., a button as depicted), which enables the user 102 to further narrow the data category. For example, section row 510 defines an operative view of a data category for shopping (e.g., for the method 200). Accordingly, section row 510 indicates that rewards data categorized as relating to shopping rewards points will be collected (e.g., with an optional button to further narrow shopping rewards points into other subsets, such as grocery shopping and clothes shopping). Similarly, section row 512 indicates that rewards data categorized as relating to dining rewards points will be collected (e.g., with an optional button to further narrow dining into other subsets, such as restaurant types). Section row 514 indicates that rewards data categorized as relating to dining rewards points will not be collected (e.g., with an optional button to further narrow travel into other subsets, such as airline points and hotel points).

The generated graphical user interface 500 further depicts a “BACK” button 516. The button 516 is depicted as a selectable (e.g., clickable) button of the generated graphical user-interface that transitions the user 102 back to a previous display (not depicted). The “SUBMIT” button 518 is depicted as a selectable (e.g., clickable) button of the generated graphical user interface, which in response to being selected creates the rewards wallet account as described above.

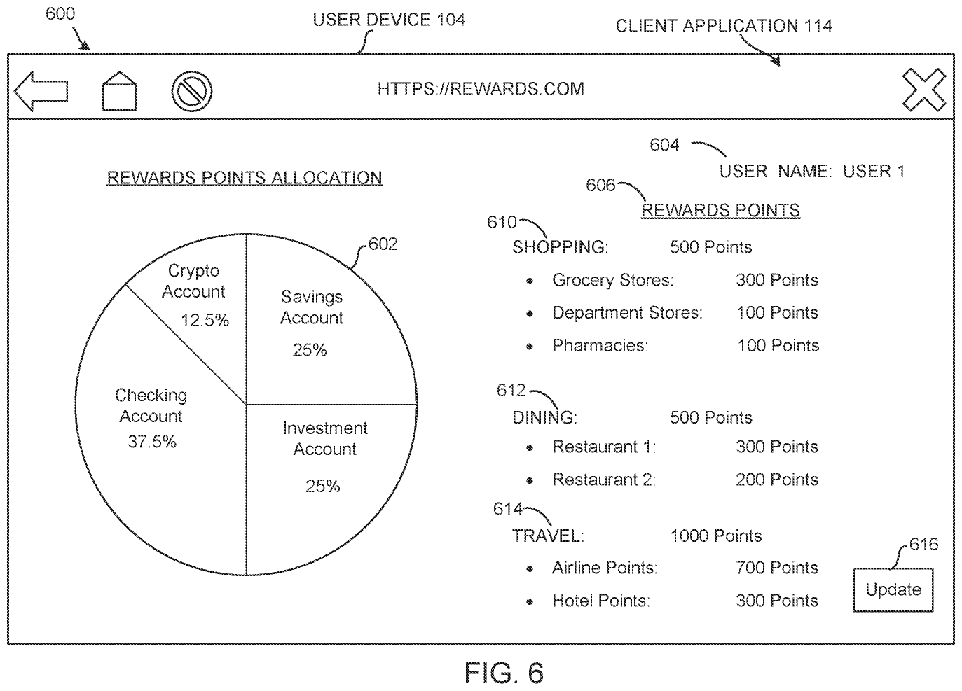

Referring now to FIG. 6, an illustration of a dynamic graphical user interface displayed on a user device showing the allocation and aggregation of the rewards points is shown according to an example embodiment. In the depicted embodiment, the user device 104 includes a display showing the graphical user interface 600 (e.g., provided by the client application 114, via the interface circuit 136), which is structured to facilitate a user (e.g., the user 102) to configure rewards data collection for one or more identified rewards providers, as described herein.

The user interface of 600 includes a rewards allocation graphic 602, the name of the user 604, a rewards points aggregation summary 606, and an update button 616. The rewards allocation graphic 602 describes the allocation of the rewards points collected by the user 102 and aggregated by the rewards platform computing system 122. In some embodiments, the rewards points allocation graphic 602 may be in the format of a pie chart. In other embodiments, the rewards points allocation graphic 602 may be in the form of a bar graph, or any other format of displaying the percentage of rewards points allocated. The name of the user 604 may also be displayed on the user interface 600. The username of the user may be preassigned by the rewards platform computing system 122 or selected by the user during registration of the rewards wallet account by the user.

The rewards points aggregation summary 606 displays a summary of rewards points collected by the user and aggregated by the rewards platform computing system 122. In some embodiments, the rewards points may be categorized into one or more sections and subsections. For example, the rewards points may be categorized based on the specific rewards provider the rewards points were collected from. For example, as shown in user interface 600, the rewards points are categorized into a shopping category 610, dining category 612, and travel category 614. The categories may be further organized by subcategories. For example, the shopping category 610 includes a grocery store subcategory, a department store subcategory, and a pharmacies subcategory as illustrative examples. Further, the dining category 612 may include a first restaurant subcategory and a second restaurant subcategory. Finally, the travel category 614 includes an airline points subcategory and a hotel points subcategory. These examples are only meant to be illustrative and are not limiting in any way. The rewards points categories and subcategories are not limited to examples described herein and can include additional or fewer categories. In some embodiments, the rewards categories are depicted as textual (e.g., string) column titles that identify the rewards data (e.g., rewards points) held in the rows and columns below and adjacent to them.

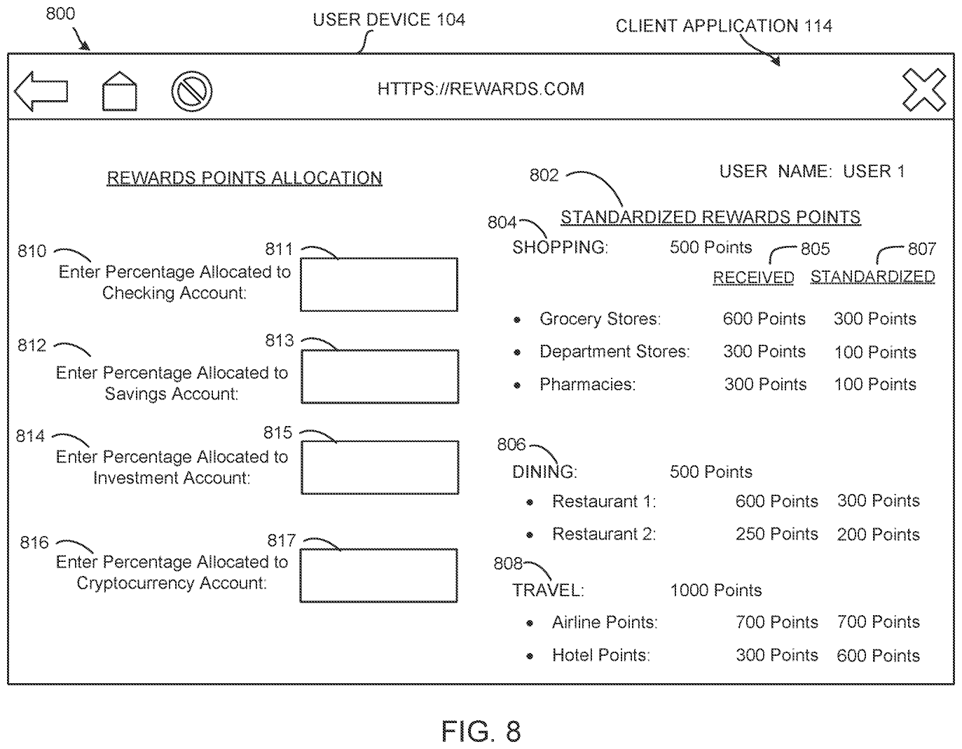

The generated graphical user interface 600 further depicts an “Update” button 616. The button 616 is depicted as a selectable (e.g., clickable) button of the generated graphical user-interface that transitions the user 102 to a different user interface display which allows the user to update the allocation of the rewards points which is described in more detail below with respect to FIG. 8 described below.

Referring now to FIG. 8, an illustration of a dynamic graphical user interface displayed on a user device showing the process of updating the allocation and aggregation of the rewards points is shown according to an example embodiment. In the depicted embodiment, the user device 104 includes a display showing the graphical user interface 800 (e.g., provided by the client application 114, via the interface circuit 136), which is structured to facilitate a user (e.g., the user 102) to configure rewards data collection for one or more identified rewards providers, as described in the method 200.

The rewards points aggregation summary 802 displays a summary of rewards points collected by the user and aggregated by the rewards platform computing system 122. In some embodiments, the rewards points aggregation summary includes a first column 805 which describes the rewards points received from the rewards providers in their raw form (e.g., before being standardized into the standard rewards points format) and a second column 807 which describes the rewards points after they have been converted into the standardized rewards points format (e.g., in some embodiments the user can configure the rewards platform computing system 122 to automatically standardize/convert rewards points received from rewards providers or may manually cause the received rewards points to be standardized/converted). Additionally, in some embodiments, the rewards points may be categorized into one or more sections and subsections. For example, the rewards points may be categorized based on the specific rewards provider that the rewards points were collected from. For example, as shown in user interface 600, the rewards points are categorized into a shopping category 804, dining category 806, and travel category 808. The categories may be further organized by subcategories as described above. These examples are only meant to be illustrative and are not limiting in any way. The rewards points categories and subcategories are not limited to the examples described herein and can include additional or fewer categories. In some embodiments, the rewards categories are depicted as textual (e.g., string) column titles that identify the rewards data (e.g., rewards points) held in the rows and columns below and adjacent to them.

The user interface of 800 includes rewards points allocation prompts 810, 812, 814, 816 along with the rewards points aggregation summary 802. Registration input prompts 810, 812, 814, 816 are depicted as textual (e.g., string) statements that describe the correlated allocation input fields 811, 813, 815, 817. For example, allocation input prompt 810 informs the user 102 that the allocation input field 811 is for entering the percentage of the aggregated allocation points they would like to allocate to a checking account, allocation input prompt 812 informs the user 102 that the allocation input field 813 is for entering the percentage of the aggregated allocation points they would like to allocate to a savings account, allocation input prompt 814 informs the user 102 that the allocation input field 813 is for entering the percentage of the aggregated allocation points they would like to allocate to an investment account, and allocation input prompt 816 informs the user 102 that the allocation input field 817 is for entering the percentage of the aggregated allocation points they would like to allocate to a cryptocurrency account. In each of these examples, the allocation may be to an account that is linked with the rewards platform 120 or to an account that does not yet exist or that is not yet opened but will be opened as part of the aggregated rewards allocation process).

The rewards points aggregation summary 802 displays a summary of rewards points collected by the user and aggregated by the rewards platform computing system 122. In some embodiments, the rewards points may be categorized into one or more sections and subsections. For example, the rewards points may be categorized based on the rewards provider the rewards points were collected from. For example, as shown in user interface 800, the rewards points are categorized into a shopping category 804, dining category 806, and travel category 808. The categories may be further organized by subcategories. For example, the shopping category 804 includes a grocery store subcategory, a department store subcategory, and a pharmacies subcategory as illustrative examples. Further, the dining category 806 may include a first restaurant subcategory and a second restaurant subcategory. Finally, the travel category 808 includes an airline points subcategory and a hotel points subcategory. These examples are only meant to be illustrative and are not limiting in any way. The rewards points categories and subcategories are not limited to examples described herein and can include additional or fewer categories. In some embodiments, the rewards categories are depicted as textual (e.g., string) column titles that identify the rewards data (e.g., rewards points) held in the rows and columns below and adjacent to them.

While this specification contains many specific implementation details and/or arrangement details, these should not be construed as limitations on the scope of any inventions or of what may be claimed, but rather as descriptions of features specific to particular implementations and/or arrangements of the systems and methods described herein. Certain features that are described in this specification in the context of separate implementations and/or arrangements can also be implemented and/or arranged in combination in a single implementation and/or arrangement. Conversely, various features that are described in the context of a single implementation and/or arrangement can also be implemented and arranged in multiple implementations and/or arrangements separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

It should be understood that no claim element herein is to be construed under the provisions of 35 U.S.C. § 112 (f), unless the element is expressly recited using the phrase “means for.”

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In some embodiments, the volatile storage media may take the form of RAM, TRAM, ZRAM), etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

1. A system comprising:
a user device executing a first application programming interface (API) configured to:
receive a log-in credential from a user to authenticate the user device, wherein the log-in credential is at least one of a biometric scan or a password;
receive an input via the authenticated user device to configure a rewards wallet account setting, wherein the authenticated user device is configured to generate and transmit a first API call requesting the input over a network, wherein the input includes a plurality of selections received via a graphical user interface, the plurality of selections including designations for data sharing, wherein a data sharing option can be enabled and disabled via selections received via the graphical user interface, wherein an enabled data sharing option at least one of: enables rewards data collection with an associated rewards provider or enables an associated rewards provider to automatically allocate aggregated rewards points to rewards points categories;
a plurality of rewards providers executing a second API configured to:
request, from a plurality of rewards providers associated with the system, data of the user associated with the designated enabled data sharing options from the plurality of selections, wherein the plurality of rewards providers generate and transmit a second API call requesting the data of the user over the network;
receive, from the plurality of rewards providers, an API response containing the data of the user associated with the designated enabled data sharing options, wherein the second API comprises a plurality of customized APIs generated based on a template developed by a rewards aggregation platform, wherein the plurality of customized APIs include custom API tokens which uniquely identify each of the plurality of rewards providers, wherein the plurality of customized APIs are each configured to communicate with a particular rewards provider of the plurality of rewards providers;
the rewards aggregation platform executing a third API configured to:
receive, from the user, the plurality of selections identifying one or more rewards providers for rewards data collection;
analyze one or more purchases made by the user to determine a classification of the data of the user corresponding to each of one or more purchases;
classify the data of the user gathered from each of the plurality of rewards providers into subsets according to a classification scheme, wherein the classification scheme comprises a set of rules to enable the data of the user to be allocated to one or more categories, wherein classifying the data comprises predictively assigning the data into one of the one or more categories;
generate a request to obtain a list of applicable reward point categories based on the plurality of selections and transmit the request over a network;
receive the list of applicable rewards points categories formatted according to a data interchange format;
parse the list of applicable rewards points categories formatted according to the data interchange format to derive a text-based list of the applicable rewards points categories;
convert the data of the user gathered from each of the plurality of rewards providers into a standardized rewards format, wherein the standardized rewards format comprises standardized rewards points, wherein converting the data of the user gathered from each of the plurality of rewards providers into a standardized rewards format includes determining a value of first rewards points received from a first rewards provider by applying a first criteria, and determining a value of second rewards points received from a second rewards provider by applying a second criteria, different than the first criteria;
aggregate the standardized rewards points;
allocate the aggregated standardized rewards points to the text-based list of applicable rewards points categories based on the rewards wallet account setting; and
the authenticated user device configured to:
display the allocated and aggregated standardized rewards points on the graphical user interface to the user, wherein the rewards points are displayed in categories based on the associated rewards provider of the plurality of rewards providers;
display an offer from at least one of the plurality of rewards providers on the graphical user interface to the user;
wherein, responsive to a selection of the offer via the authenticated user device, the rewards aggregation platform performs a transaction with the rewards provider associated with the selected offer and using a first amount of the aggregated standardized rewards points comprising the first rewards points received from the first rewards provider and the second rewards points received from the second rewards provider, the first rewards provider providing a first rewards provider mobile application configured to enable a transaction to be conducted using the first rewards points, the second rewards provider providing a second rewards provider mobile application configured to enable a transaction to be conducted using the second rewards points, and wherein operating the user device to execute the first API, display the allocated and aggregated standardized rewards points on the graphical user interface, and conduct the transaction requires at least one of less power, less CPU clock cycles, less memory allocation, or less network bandwidth than would otherwise be required to operate the first rewards provider mobile application and the second rewards provider mobile application on the user device to perform two separate transactions using the first rewards points and the second rewards points, respectively.

2. The system of claim 1, further comprising a user data repository containing data relating to a plurality of users, wherein the third API is configured to gather standardized rewards points from the user data repository, wherein aggregating the standardized rewards points comprises aggregating the standardized rewards points from the data of the user gathered from each of the plurality of rewards providers and from the user data repository.

3. The system of claim 1, wherein the third API is configured to:
allocate an amount of rewards points from the aggregated standardized rewards points to a first category; and
provide the user with selectable options to further allocate the amount of rewards points,
wherein the first category is at least one of a checking account, a saving account, an investment account, and a cryptocurrency account.

4. The system of claim 1, wherein the data of the user received from a first rewards provider of the plurality of rewards providers is received in a first rewards point format, and wherein the data of the user received from a second rewards provider of the plurality of rewards providers is received in a second rewards point format.

5. The system of claim 1, wherein the data of the user received from a first rewards provider of the plurality of rewards providers is transaction data.

6. The system of claim 5, wherein the third API is configured to determine a value of standardized rewards points based on the data of the user received from the first rewards provider based on a predetermined transaction conversion rate.

7. (canceled)

8. A non-transitory computer readable media having computer-executable instructions embodied therein that, when executed by a server system, causes the server system to perform operations comprising:
receiving, via a user device executing a first application programming interface (API), a log-in credential from a user to authenticate the user device, wherein the log-in credential is at least one of a biometric scan or a password;
receiving, from the first API executed by a user device, an input received via the authenticated user device to configure a rewards wallet account setting, wherein the authenticated user device is configured to generate and transmit a first API call requesting the input over a network, wherein the input includes a plurality of selections received via a graphical user interface, the plurality of selections including designations for data sharing, wherein a data sharing option can be enabled and disabled via selections received via the graphical user interface, wherein an enabled data sharing option at least one of: enables rewards data collection with an associated rewards provider or enables an associated rewards provider to automatically allocate aggregated rewards points to rewards points categories;
requesting, by a second API executed by a plurality of rewards providers associated with the server system, data of the user associated with the designated enabled data sharing options from the plurality of selections, wherein the plurality of rewards providers generate and transmit a second API call requesting the data of the user over the network;
receiving, by the second API and from the plurality of rewards providers, an API response containing the data of the user associated with the designated enabled data sharing options, wherein the second API comprises a plurality of customized APIs generated based on a template developed by the rewards aggregation platform, wherein the plurality of customized APIs include custom API tokens which uniquely identify each of the plurality of rewards providers, wherein the plurality of customized APIs are each configured to communicate with a particular rewards provider of the plurality of rewards providers;
receiving, by a third API executed by a rewards aggregation platform, from the user, the plurality of selections identifying one or more rewards providers for rewards data collection;
analyzing, by the third API, one or more purchases made by the user to determine a classification of the data of the user corresponding to each of one or more purchases;
classifying, by the third API, the data of the user gathered from each of the plurality of rewards providers into subsets according to a classification scheme, wherein the classification scheme comprises a set of rules to enable the data of the user to be allocated to one or more categories, wherein classifying the data comprises predictively assigning the data into one of the one or more categories;
generating, by the third API, a request to obtain a list of applicable reward point categories based on the plurality of selections and transmit the request over a network;
receiving, by the third API, the list of applicable rewards points categories formatted according to a data interchange format;
parsing, by the third API, the list of applicable rewards points categories formatted according to the data interchange format to derive a text-based list of the applicable rewards points categories;
converting, by the third API, the data of the user gathered from each of the plurality of rewards providers into a standardized rewards format, wherein the standardized rewards format comprises standardized rewards points, wherein converting the data of the user gathered from each of the plurality of rewards providers into a standardized rewards format includes determining a value of first rewards points received from a first rewards provider by applying a first criteria, and determining a value of second rewards points received from a second rewards provider by applying a second criteria, different than the first criteria;
aggregating, by the third API, the standardized rewards points;
allocating, by the third API, the aggregated standardized rewards points to the text-based list of applicable rewards points categories based on the rewards wallet account setting; and
displaying, by the authenticated user device, the allocated and aggregated standardized rewards points on the graphical user interface to the user, wherein the rewards points are displayed in categories based on the associated rewards provider of the plurality of rewards providers;
displaying, by the authenticated user device, an offer from at least one of the plurality of rewards providers on the graphical user interface to the user;
wherein, responsive to a selection of the offer via the authenticated user device, the rewards aggregation platform performs a transaction with the rewards provider associated with the selected offer and using a first amount of the aggregated standardized rewards points comprising the first rewards points received from the first rewards provider and the second rewards points received from the second rewards provider, the first rewards provider providing a first rewards provider mobile application configured to enable a transaction to be conducted using the first rewards points, the second rewards provider providing a second rewards provider mobile application configured to enable a transaction to be conducted using the second rewards points, and wherein operating the user device to execute the first API, display the allocated and aggregated standardized rewards points on the graphical user interface, and conduct the transaction requires at least one of less power, less CPU clock cycles, less memory allocation, or less network bandwidth than would otherwise be required to operate the first rewards provider mobile application and the second rewards provider mobile application on the user device to perform two separate transactions using the first rewards points and the second rewards points, respectively.

9. The non-transitory computer readable media of claim 8, wherein the operations further comprise gathering, by the third API, standardized rewards points from a user data repository containing data relating to a plurality of users, wherein aggregating the standardized rewards points comprises aggregating the standardized rewards points from the data of the user gathered from each of the plurality of rewards providers and from the user data repository.

10. The non-transitory computer readable media of claim 8, wherein the operations further comprise:
allocating, by the third API, an amount of rewards points from the aggregated standardized rewards points to a first category; and
providing, by the third API, the user with selectable options to further allocate the amount of rewards points, wherein the first category is at least one of a checking account, a saving account, an investment account, and a cryptocurrency account.

11. The non-transitory computer readable media of claim 8, wherein the data of the user received from a first rewards provider of the plurality of rewards providers is received in a first rewards point format, and wherein the data of the user received from a second rewards provider of the plurality of rewards providers is received in a second rewards point format.

12. The non-transitory computer readable media of claim 8, wherein the data of the user received from a first rewards provider of the plurality of rewards providers is transaction data.

13. The non-transitory computer readable media of claim 12, wherein the operations further comprise determining, by the third API, a value of standardized rewards points based on the data of the user received from the first rewards provider based on a predetermined transaction conversion rate.

14. A method comprising:
receiving, via a user device executing a first application programming interface (API), a log-in credential from a user to authenticate the user device, wherein the log-in credential is at least one of a biometric scan or a password;
receiving, from the first API executed by a user device, an input received via the authenticated user device to configure a rewards wallet account setting, wherein the authenticated user device is configured to generate and transmit a first API call requesting the input over a network, wherein the input includes a plurality of selections received via a graphical user interface, the plurality of selections including designations for data sharing, wherein a data sharing option can be enabled and disabled via selections received via the graphical user interface, wherein an enabled data sharing option at least one of: enables rewards data collection with an associated rewards provider or enables an associated rewards provider to automatically allocate aggregated rewards points to rewards points categories;
requesting, by a second API executed by a plurality of rewards providers, data of the user associated with the designated enabled data sharing options from the plurality of selections, wherein the plurality of rewards providers generate and transmit a second API call requesting the data of the user over the network;
receiving, by the second API and from the plurality of rewards providers, an API response containing the data of the user associated with the designated enabled data sharing options, wherein the second API comprises a plurality of customized APIs generated based on a template developed by the rewards aggregation platform, wherein the plurality of customized APIs include custom API tokens which uniquely identify each of the plurality of rewards providers, wherein the plurality of customized APIs are each configured to communicate with a particular rewards provider of the plurality of rewards providers;
receiving, by a third API executed by a rewards aggregation platform, from the user, the plurality of selections identifying one or more rewards providers for rewards data collection;
analyzing, by the third API, one or more purchases made by the user to determine a classification of the data of the user corresponding to each of one or more purchases;
classifying, by the third API, the data of the user gathered from each of the plurality of rewards providers into subsets according to a classification scheme, wherein the classification scheme comprises a set of rules to enable the data of the user to be allocated to one or more categories, wherein classifying the data comprises predictively assigning the data into one of the one or more categories;
generating, by the third API, a request to obtain a list of applicable reward point categories based on the plurality of selections and transmit the request over a network;
receiving, by the third API, the list of applicable rewards points categories formatted according to a data interchange format;
parsing, by the third API, the list of applicable rewards points categories formatted according to the data interchange format to derive a text-based list of the applicable rewards points categories;
converting, by the third API, the data of the user gathered from each of the plurality of rewards providers into a standardized rewards format, wherein the standardized rewards format comprises standardized rewards points, wherein converting the data of the user gathered from each of the plurality of rewards providers into a standardized rewards format includes determining a value of first rewards points received from a first rewards provider by applying a first criteria, and determining a value of second rewards points received from a second rewards provider by applying a second criteria, different than the first criteria;
aggregating, by the third API, the standardized rewards points;
allocating, by the third API, the aggregated standardized rewards points to the text-based list of applicable rewards points categories based on the rewards wallet account setting; and
displaying, by the user device, the allocated and aggregated standardized rewards points on the graphical user interface to the user, wherein the rewards points are displayed in categories based on the associated rewards provider of the plurality of rewards providers;
displaying, by the user device, an offer from at least one of the plurality of rewards providers on the graphical user interface to the user;
wherein, responsive to a selection of the offer via the authenticated user device, the rewards aggregation platform performs a transaction with the rewards provider associated with the selected offer and using a first amount of the aggregated standardized rewards points comprising the first rewards points received from the first rewards provider and the second rewards points received from the second rewards provider, the first rewards provider providing a first rewards provider mobile application configured to enable a transaction to be conducted using the first rewards points, the second rewards provider providing a second rewards provider mobile application configured to enable a transaction to be conducted using the second rewards points, and wherein operating the user device to execute the first API, display the allocated and aggregated standardized rewards points on the graphical user interface, and conduct the transaction requires at least one of less power, less CPU clock cycles, less memory allocation, or less network bandwidth than would otherwise be required to operate the first rewards provider mobile application and the second rewards provider mobile application on the user device to perform two separate transactions using the first rewards points and the second rewards points, respectively.

15. The method of claim 14, further comprising gathering, by the third API, standardized rewards points from a user data repository containing data relating to a plurality of users, wherein aggregating the standardized rewards points comprises aggregating the standardized rewards points from the data of the user gathered from each of the plurality of rewards providers and from the user data repository.

16. The method of claim 14, further comprising:
allocating, by the third API, an amount of rewards points from the aggregated standardized rewards points to a first category; and
providing, by the third API, the user with selectable options to further allocate the amount of rewards points.

17. The method of claim 14, wherein the data of the user received from a first rewards provider of the plurality of rewards providers is received in a first rewards point format, and wherein the data of the user received from a second rewards provider of the plurality of rewards providers is received in a second rewards point format.

18. The method of claim 14, wherein the data of the user received from a first rewards provider of the plurality of rewards providers is transaction data.

19. The method of claim 18, further comprising determining, by the third API, a value of standardized rewards points based on the data of the user received from the first rewards provider based on a predetermined transaction conversion rate.

20. (canceled)
